(19) United States
(12) Patent Application Publication
(10) Pub. No.: US 2004/0215612 A1
(43) Pub. Date: Oct. 28, 2004

(54) Semi-boolean arrangement, method, and system for specifying and selecting data objects to be retrieved from a collection

(76) Inventor: Moshe Brody, Kfar Sava (IL)

Correspondence Address: Moshe Brody, Rehov Ovadia Ha-Navii 6, Kfar Sava, 44342, IL

(21) Appl. No.: 10/830,565

(22) Filed: Apr. 21, 2004

Related U.S. Application Data
(60) Provisional application No. 60/466,837, filed on Apr. 28, 2003.

(51) Int. Cl. G06F 7/00

(52) U.S. Cl. 707/3

(57) ABSTRACT

A semi-Boolean arrangement for specifying data objects to be retrieved from a collection, and a method and system for selecting the data objects, which combine text searching and set operations on existing subsets of data objects from the collection. This optimized relaxation of a full Boolean search complies with natural human language patterns to greatly simplify query structure, formulation, and interpretation without loss of generality. The use of subsets, including arbitrary subsets compiled by the user or a proxy, enables the user to control the level of vagueness and ambiguity inherent in text searching to reduce under-inclusion without relying on evidence sets or meta-data such as keywords, as well as to reduce over-inclusion, for which there is currently no satisfactory means of control. The use of arbitrary subsets instead of keywords also offers advantages by not requiring modifications to the data objects in order to categorize the data objects by ideas or concepts contained therein. A formal query structure is provided, which conforms to natural human language and conceptualization patterns allowing simple and intuitive formulation of an important class of Boolean queries without parentheses for grouping expressions, and in a manner which facilitates automatic parsing and query construction. Also, a general format for a graphical user interface is presented, which works with the user to formulate queries and guarantees that all queries will be a priori syntactically-correct, thereby completely eliminating the possibility of user syntax errors and the need for notifying users thereof.

The present application claims benefit of U.S. Provisional Patent Application No. 60/466837 filed Apr. 28, 2003.

### FIELD OF THE INVENTION

The present invention relates to knowledge management and the retrieval of particular data objects from a collection of data objects, such as a database, and, more particularly, to an arrangement for specifying the data objects to be retrieved, and a method and system for selecting and retrieving the data objects.

### BACKGROUND OF THE INVENTION

The retrieval of one or more particular data objects from a collection of data objects, such as a database, requires a means of specifying, in a query, the characteristics of the data objects to be retrieved. For general-purpose databases, queries are typically expressed in terms of formal languages.

As is shown and discussed in detail below, the current art presently features two distinct domains of interest when considering the retrieval of data objects from a data object collection:

1. the domain of formal databases, in which rigorous mathematical structures are imposed on the data content (depicted in FIG. 1); and

2. the domain of generalized, or “Internet-type” data object collections, which are characterized by a lack of formal structure regarding information content (depicted in FIG. 2).

It is emphasized that examples, descriptions, or characterizations herein which refer to the “Internet” or “World-Wide Web” with regard to data object collections (such as identified by the phrase “Internet-type” data object collections) are non-limiting and are solely for purposes of denoting generalized data object collections in a familiar fashion, and that the principles thereof are not restricted to the World-Wide Web, the Internet, nor to any network whatsoever. This is important to note, because the type of data object collection which is featured on the Internet today is increasingly becoming available in many places other than across networks. For example, an individual user may compile a large quantity of such data objects that contain private or confidential information (and thus will be stored locally only), but which may still require efficient query for retrieval. As just mentioned, even though a data object collection may not appear on a network, such a data object collection may be exemplified herein with reference to an “Internet-type” of data object collection for convenience of illustration, because of the great familiarity many people have with the data objects available on the Internet and with the methodologies of searching and retrieving such data objects therefrom.

### Formal Databases

FIG. 1 conceptually depicts the components of an exemplary (but typical) formal database 101 (in this case, a “relational” database is shown), which include one or more tables, such as a table 103 containing one or more records, such as a record 105. The structure of record 105 is specified by a schema 107 which can include one or more primitive data objects such as an integer 109, a floating-point number 111, a decimal number 113, a date 115, a character 117, a character field 119, a character string 121, a boolean 123, a pointer 125.

There are additional formal structures within the “relational” database, and there are other kinds of formal databases known in the art besides “relational” databases. The important point to note, however, is that there exist precise and rigid mathematical definitions and relationships between the different objects or elements of any formal database, and the data attributes of those objects or elements.

As indicated in FIG. 1, what is contained in a formal database is generally regarded as low-level information, and referred to as “data”.

### Formal Database Languages

Many database managers employ specialized formal languages for queries, and in some cases, such queries may take the form of sequential declarations, instructions, statements, and/or commands related to the data attributes of the elements of the database, in a manner similar to the programming of a computer. An example of this form of database query follows. This example is of a hypothetical query that finds all employees assigned to the underwriting division of a hypothetical business:

Dim Criteria As String

Dim DB As Database

Dim Coll As Recordset

Criteria=“Division=‘Underwriting’”

Set DB=DBEngine.Workspaces(0).Databases(0)

Set Coll=DB.OpenRecordset(“Employees”, DYNASET)

Coll.FindFirst Criteria

Do Until Coll.NoMatch

Coll.FindNext Criteria

EndDo

Unfortunately, the complexity of such a formalism makes it difficult to formulate and understand queries expressed in this manner. Moreover, different database managers typically employ different formal languages, making it difficult for a person familiar with one particular database manager to construct and understand queries for another database manager.

### Query Languages

In an attempt to simplify the formulation of queries, a formal language known as the Structured Query Language (SQL) was developed for use with relational databases, and has become a common de-facto standard for uniformity across a spectrum of database managers. In SQL and similar query languages, queries take the form of constructions similar to natural language sentences, featuring imperatives, predicates, and dependent clauses compounded by prepositional, correlative, and conjunctive expressions. An example of a query in SQL follows. This example is of a hypothetical query that selects all names of employees assigned to the underwriting division of a hypothetical business, and is similar (but not identical) in action to the query of the previous example above:

SELECT [Last Name] & “,” & [First Name] AS Name FROM Divisions LEFT JOIN Employees ON Divisions.[Division]=Employees.[Division] WHERE [Division]=‘Underwriting’

Despite the improvement in clarity introduced by languages such as SQL, the formulation of queries still requires some specialized training and experience. In working environments where such formal languages are used extensively, familiarity with the languages is a reasonable requirement and poses no particular problem. But as collections of data objects become more accessible to the general public (for example, via wide-area networks, such as the Internet), requiring that users be familiar with any kind of formal language imposes severe limitations on the ability of the average user to formulate an effective query. Even in the case of SQL, for example, users need to be familiar with:

the syntactic structure of a query statement;

the keywords, conjunctions, and other language elements of a query (e.g., FROM WHERE);

the underlying database model and its directives (e.g., SELECT, JOIN); and

the names of the elements in the particular database in use (e.g., Divisions, Employees), as well as the values these elements can assume (e.g., ‘Underwriting’).

If the user formulates a query containing a typographical error, a syntax error, or an error in the name of an element, the query will be rejected. Thus, the user has to concentrate as much on the form of the query as to the substance of the query.

### Generalized, or “Internet-Type”, Data Object Collections

In addition to the complexities discussed above, there are new challenges introduced by the emergence of new forms of data object collections that are not amenable to query in the same manner as formal databases. The new forms of generalized data object collections are exemplified by the “Internet-type” of data object collection, containing kinds of data objects that are generally not found in traditional formal databases. These data object collections typically contain text documents or hypertext documents, with optional associated ancillary data fields holding relevant date and (natural) language information. Embedded in these hypertext documents are various other kinds of data objects, such as images, motion pictures, sounds, computer software, and computer data. On the Internet, for example, there is on the “World-Wide Web” a data object collection containing a large number of “pages” of text and hypertext information, along with associated graphics, audio data, and other computer-readable files. (It is to be noted that, although the World-Wide Web constitutes a data object collection according to the present invention, such a data object collection does not qualify as a “database” in the formal sense, and therefore “generalized data object collections” are more broadly-defined than “formal databases”, as suggested by the above partition of data object collections into two distinct domains.)

FIG. 2 conceptually depicts the components of a generalized data object collection of the sort exemplified by the Internet “World-Wide Web”. A data object collection 201 contains objects such as a hypertext page 203, a hypertext page 205, and a hypertext page 207. Embedded in hypertext page 205 is a link 209 to hypertext page 207. A document 211 and an image 213 are embedded in hypertext page 203. Computer-readable data 215 and computer software 217 are embedded in hypertext page 207. And audio/music 219 and video/motion picture 221 are embedded in hypertext page 205.

There are additional kinds of data objects within such a generalized data object collection, and there are other examples of such data object collections, which utilize other frameworks besides hypertext pages. The important point to note, however, is that although there are precise and formal mathematical structures regarding the formats for these various objects, the nature of the information contained therein is relatively unconstrained. There do not exist rigid mathematical relationships between the different data object structures within a generalized data object collection, as there are in formal databases.

As indicated in FIG. 2, what is contained in such a generalized data object collection is usually regarded as being at a higher-level than mere “data”, and is usually thought of as “information”.

Because Internet web-sites and news groups feature data objects which are characterized primarily by their text content, Internet “search engines” enable a person having no special training in the use of database managers to query a very large data collection of Internet web-sites for specific information, via text-searching queries. From the immense popularity of the various Internet search engines, it is clear that the ability to query generalized collections of data objects is of great value to a very large base of users. Text searching is simple and intuitive to employ, and has many advantages for unskilled users.

Other data object collections of the sort represented on the Internet include, but are not limited to: newspaper and journal archives; books and other documents; reference material; audiovisual material; historical accounts; biographical and genealogical information; medical and scientific abstracts; geographical information; correspondence; case records; government documents; and patent literature. All of these are also candidates for the same style of text-searching query. Moreover, as previously noted, the data object collection need not be large nor contained on a network, but can also be relatively small and kept locally, such as by a single user who wishes to maintain a data object collection of specialized information.

### Text-Searching Queries

For text-searching queries (such as those over the Internet), there are strict limitations on the search criteria. The principal search criteria are related to words or phrases embedded in the text (or hypertext) of data objects, such as web-site pages; and secondary search criteria are related to other variables, such as the date of posting on the Internet, and to the specific natural language employed (e.g., English, French, German, etc.). A result of these limitations is that the Internet-style text-searching query can only approximately specify what the user is seeking. (It is noted that in the examples which follow, text-searching queries are illustrated as operating on mixed case words and phrases. It is understood, however, that text searching may be selected to be case insensitive, as is commonly done in the art.)

As a simple example of some of the limitations of queries based on text searching, consider a query of the World-Wide Web for pages that reference both John Coltrane and Miles Davis, for the purpose of compiling a discography of jazz performances featuring these artists together. The most straightforward text-searching query would be based on the criteria (“John Coltrane” AND “Miles Davis”). These two performers were so prominent and important in the history of American jazz, however, that many of the desired web pages might not contain their first names, but might refer to them in the text merely as “Coltrane” and “Davis”. Thus, the above query would be “under-inclusive.” A more complete set of results would be obtained by a text-searching query based on the criteria (“Coltrane” AND “Davis”). Unfortunately, though, this query would find a large number of extraneous web pages, because the results would include, in addition to John Coltrane and Miles Davis, unwanted references to Robbie Coltrane and Warwick Davis, two popular motion-picture actors who have appeared on-screen together. Thus, the modified query above would be “over-inclusive”. In addition, many jazz enthusiasts often refer to Miles Davis simply as “Miles” and John Coltrane as “Trane”, and this further complicates a text-searching query. A text-searching query that takes these considerations into account might look like: ((“Coltrane” AND “Davis”) OR (“Trane” AND “Davis”) OR (“Coltrane” AND “Miles”) OR (“Trane” AND “Miles”)) AND NOT (“Robbie Coltrane” OR “Warwick Davis”). Despite the complexity of this text-searching query, however, it is possible that desired data objects will be still excluded and/or that unwanted data objects will still be retrieved. Specifically, the exclusion of data objects based on the occurrence of references to Robbie Coltrane and Warwick Davis is the result of particular experience in running the query and there is no guarantee that this exclusion is exhaustive—there might very well be other “Coltrane”-“Davis” pairs that do not refer to the intended jazz musicians, and these would have to be handled by additional terms in the text-searching query. Moreover, a data object with reference to John Coltrane and Miles Davis will be erroneously excluded if there also happens to be an incidental reference there to Robbie Coltrane or Warwick Davis. That is, such a query is likely both under-inclusive and over-inclusive at the same time.

Thus, it is seen that a text-searching query can easily become complicated and clumsy, and yet still only approximate the intended search criteria. This condition often leads to the retrieval of either a very large number of data objects, or alternatively, a very small number of data objects or no data objects at all. It is not uncommon for Internet text-searching queries to be excessively over-inclusive, and retrieve hundreds of thousands of data objects matching the specified criteria—far more than can possibly be utilized, but become excessively under-inclusive by retrieving no data objects at all when a small change is made to the criteria. Although the Internet search engines presently available do enable users to find material that would otherwise be impossible to locate, there are fundamental limitations in the current formulation of text-searching queries that result in such inefficiencies and difficulties.

### Limitations in the Prior Art

In a general sense, the above example illustrates that, although data object collections such as those found on the Internet can easily store ideas and concepts, it is not always straightforward for users to formulate queries to retrieve data objects containing information related to those ideas and concepts. Whereas the user is seeking specific information based on the meaning and content of the information, the constraints of text-searching queries require searching based on the limited and irregular capacity of linguistic expressions to assert meaning and content. In other words, when searching data object collections such as those found on the Internet, the users are searching for information based on ideas and concepts, but must express searching criteria in terms of words and phrases, which are not precisely the same as ideas and concepts (as illustrated by the previous example). This limitation introduces vagueness and ambiguity into the searching process, which tends to result in under-inclusive and/or over-inclusive queries. A certain amount of vagueness and ambiguity can be desirable when searching for ideas and concepts embedded in data objects, but it is also desirable to be able to control the degree of the vagueness and ambiguity. This is unfortunately very difficult to do in the framework of prior-art text-searching queries.

Well-known attempts to correct the some of the above limitations include the use of meta-tagging in the hypertext documents. Meta-tags are meta-data inserted into the hypertext documents by the author or other person knowledgeable about the contents, in an effort to anticipate imprecise user queries. The meta-tags are in the hypertext source code and are detected by search engines, but are invisible on the user's screen, so it is possible to incorporate a large number of meta-tags without detracting from the readability of the document. There are several problems related to the use of meta-tags, however, which prevents them from being a wholly satisfactory solution to the above problems. First of all, the use of meta-tags addresses only the issue of under-inclusive queries—the failure to retrieve certain relevant data objects. The problem of over-inclusive queries is not solved by meta-tags. Furthermore, the effort required to insert and maintain meta-tags introduces additional difficulties.

Another well-known attempt to correct some of these limitations is the use of evidence sets, which contain words or phrases organized into topics. Search engines can access such evidence sets to expand text-searching queries. Unfortunately, however, the use of evidence sets, like meta-tags, addresses only the issue of under-inclusive queries, and also introduces additional difficulties in the creation and maintenance of the evidence sets.

It is widely recognized in the art that the problem of over-inclusion in queries is a serious one that can easily cause a query to return a huge number of irrelevant data objects that render the query largely useless by inundating the user with an overwhelming number of data objects that do not contain any of the desired information.

Unfortunately, although there are some solutions for the problem of under-inclusion (e.g., meta-tags and evidence sets), there are inadequate solutions for the problem of over-inclusion. The only strategy which has so far met with any success in this area is that of the “vertical portal” or “vortal”, a specialized topical site on the World-Wide Web within the Internet, which is dedicated to a specialized field. For example, if there were a vortal dedicated to Web pages (and links) about jazz musicians, the text-searching query of the previous example involving John Coltrane and Miles Davis, when presented to such a vortal, would be expected to exclude extraneous references, such as those to Robbie Coltrane and Warwick Davis, thereby greatly alleviating the problem of over-inclusion. The use of vortals, however, is limited for a number of reasons. First, creating a vortal requires a major effort that must be justified by a large need or commercial opportunity, and this restricts the availability and applicability of vortals. Second, users have no control over vortal properties. And third, there is currently no way for users to combine the action of vortals. A user cannot prepare a text-searching query to be sent to multiple vortals such that the result will be the intersection or union of the individual retrieved sets. Vortals are not usable as subsets of the World-Wide Web, but in practical terms constitute disjoint data object collections.

It is to be noted that traditional formal databases do not experience problems with vagueness and ambiguity, under-inclusion, or over-inclusion. But this is only because the database formalism restricts the freedom of expression of information stored in the database to precisely-defined mathematical entities. Databases can store numerical values (such as quantities, monetary amounts, etc.) or character string values (such as names, telephone numbers, etc.), but cannot store ideas or concepts. Because ideas and concepts are excluded from representation in traditional databases, the vagueness and ambiguity of the text-searching query is absent from queries in such databases, and hence the issues of under-inclusion and over-inclusion are not applicable to formal databases. It should be mentioned, however, that some databases have been developed which can also store pointers to free-form text information (such as journal articles or abstracts) and thereby can store ideas and concepts. But in such cases these databases must also rely on text-searching queries if the free-form text information is to be used in selection criteria for the data objects to be retrieved.

Thus, as noted previously, there are two distinct domains in the prior art for the storage, retrieval, and query of data objects included within data object collections:

1. formal databases (depicted in FIG. 1), which handle precisely-defined mathematical entities, whose queries must be formulated skillfully in conformity with special rules requiring special training; and which do not involve any vagueness or ambiguity in the queries, and

2. Generalized data object collections (also referred to herein as “Internet-type” data object collections, a non-limiting example of which is depicted in FIG. 2), which handle ideas and concepts, which rely on text-searching queries that may be easily formulated by ordinary persons without special training and without using special rules, but which involve a hard-to-control vagueness and ambiguity in the queries.

(Once again, as previously noted, the term “Internet-type”, and references to the Internet and World-Wide Web, as used herein are non-limiting and do not restrict the characterized data object collections to be associated with networks in any way.)

As data object collections become more diverse, more commonplace, more accessible by the average person, and more important to the general public, there is an increasing need for more precision in formulating queries, but without the introduction of serious complexities in the structuring of the data object collections and the management thereof. This will require both a means of controlling the vagueness and ambiguity inherent in text-searching queries, as well as a simple scheme so that the average person can easily formulate queries to retrieve desired data objects.

There is thus a need for, and it would be highly advantageous to have, a way of specifying the data objects to be retrieved from a data object collection, in which there is control over the vagueness and ambiguity of text-searching queries, and in a manner that is easily formulated by the average user without special training. These goals are met by the present invention.

### Definitions

Some terms as used herein to denote aspects particularly related to the present invention and the field thereof include:

collection (in the context of the present invention)—any set of data objects. Also referred to herein as a data collection or a data object collection. The term “collection” as used herein connotes certain basic mathematical “set” properties, relations, and operations including, but not limited to: union; intersection; complement; size (“order”); and subset. The term “collection” is used herein, rather than the term “set” to avoid confusion with existing terms such as “data set”, “dataset”, “recordset”, “dynaset”, and so forth, which are used in the art to denote specialized data object groupings that may not have substantially the same applicability, properties, and/or functions as the term “collection” is intended to convey herein. Where the term “set” is used, this term denotes the regular mathematical concept. A set may be empty. The mathematical term “subset” is used herein, with the usual definition, to apply to a sub-collection of data objects. The term “subset” as used herein is not limited to a “proper subset”, so that a subset may include all the elements of the entire collection. It is also noted that inclusion of a data object in a collection or subset may be done by inclusion of the data object itself within the collection or subset, or by inclusion of a local accessor (see below) corresponding to that data object within the collection or subset.

database—a collection of data objects having a formal mathematical structure.

database manager—an automated system for handling operations involving a database, including, but not limited to: storing data objects in the database; and retrieving objects from the database. In particular, a database manager typically has an associated formalism or scheme for formulating queries.

data object—an element of machine-readable data that can be treated as a collective entity. Data objects are processed, manipulated, stored, accessed, and retrieved by machines, including, but not limited to: computers; data processors; database managers; storage devices and systems; data networks; and communications devices and systems. Data objects reside in machine-accessible areas including, but not limited to: storage media; machine memory; device registers or cache; and data networks, and the term includes data objects in transit over networks or communication systems. In the context of the present invention, data objects include, but are not limited to: numbers; Boolean values (true and false); characters; character fields; character strings; tables and structures; vectors, matrices, and tensors; documents; pointers and addresses; machine-readable data files and computer software, including multi-media data files, images, graphics, motion pictures, and audio; data streams, including multi-media data streams; web pages; and newsgroup pages.

data processing device—any automated device or mechanism for manipulating or processing data, including, but not limited to computers; computer systems; servers; storage devices and systems; communications and networking equipment.

data terminal—any device or mechanism, or set of devices or mechanisms, which is capable of presenting output information to a user and of receiving input information from a user. Information may be presented in visible, audible, or tactile form, and may be received in similar fashion. The term “data terminal” herein denotes, but is not limited to: computer terminals; personal computers; combinations of monitors and keyboards configured to perform any computer interface function; touch-sensitive screens; personal digital appliances (PDA's); telephonic devices (such as cellular telephones); control panels having visual indicators and switches; and audio/visual devices for signaling a user and receiving selections therefrom.

formal data attribute—a property of a data object which allows unambiguous and precise selection of that data object by a mathematical rule. A non-limiting example of a formal data attribute is the creation time of a data object (often stored with the data object), and a non-limiting example of a mathematical rule for selection from a data object collection is to select all data objects whose creation time is before a specified time.

local accessor—a machine-usable formal entity which allows a device that manages a data object collection substantially immediate and guaranteed access to a data object within the collection. Local accessors include, but are not limited to, memory pointers, memory addresses, and memory offsets. Because a local accessor provides substantially immediate and guaranteed access to the data object, the local accessor serves as a transparent proxy for the data object itself The intention is that, to the user there be no discernable difference between including a local accessor within a data object collection or subset thereof rather than including the data object itself But in terms of processing algorithms and execution, it is usually much more efficient and versatile to include a local accessor rather than the data object itself. Therefore, a reference which does not allow a device that manages the collection or subset substantially immediate and guaranteed access to that data object is not a local accessor. For example, an Internet “Universal Resource Locator” (“URL”) or other sort of Internet “link” is not a local accessor, because there are user-perceptible time delays in retrieving a data object via a URL, and there is no substantial guarantee that the data object can be accessed (e.g., the URL or link may no longer be valid). Thus, for purposes of the present invention, an assemblage of Internet URL's or links does not constitute a data object collection or a subset thereof. It may be possible, however, to define local accessors on a well-defined high-speed local-area network, so that a data object collection could exist as a set of local accessors to data objects stored on such a network.

machine-accessible data storage—any data storage for use by machine, including, but not limited to: computer memory; data storage devices; data storage media; and network-accessible data; where the machine-readable codes are executable or usable as input by a machine.

machine-readable—intended to be used as direct input data for a machine, and embodied in a form usable as such by a machine without direct human intervention or interpretation. Examples of machines include, but are not limited to: computers; data processors; communications equipment; and other similar devices. Examples of embodiments of machine-readable data include, but are not limited to: data recorded on machine-readable data storage media; data stored in machine-accessible memory; data stored in machine registers or cache; and data stored or available over a data network.

query—The terms “query” and “queries” herein denote any data structure residing in machine-accessible data storage, for specifying the data objects to be retrieved from a collection. A query is thus in machine-readable form, for example as in machine-accessible memory or on storage media, for use by a computer, a data network, or other data processing device in automated processing.

text typing—the process or act of entering arbitrary text in the form of words, phrases, or character strings via an input device including, but not limited to a keyboard, keypad, touch-sensitive surface, stylus, light pen, bar code scanner, manual OCR reader, microphone, or other suitable device. Text typing is distinct from using the input device to specify commands, including, but not limited to: cursor control commands; page control commands; scrolling commands; and commands for selecting an item from a list. Furthermore, the arbitrary nature of text typing is emphasized. As a non-limiting example, when an input device capable of being used for text typing is used for selecting an item from a list, such a usage is not considered to be text typing, even if the selection is made by entering characters or character strings corresponding to characters or character strings associated with a desired selection within the list, because the selection is constrained to the items in the list and therefore the entering of characters and/or character strings is not arbitrary, but is likewise constrained. The term “text typing” as used herein is also construed to include the input of text by vocal or other non-contact means.

### SUMMARY OF THE INVENTION

The present invention is of a method, arrangement, and system for formulating queries for retrieving data objects from a generalized data object collection, by utilizing subsets of the data object collection combined using familiar set operations (intersection, union, complement) in a novel semi-Boolean query formalism that greatly simplifies query structure and interpretation without loss of generality.

It is an objective of the present invention to allow the formulation of queries for retrieval of data objects from generalized data object collections without requiring any specialized training in formal query languages, without requiring the user to input keywords or operators via text typing, without requiring the user to separate and/or arrange elements within the queries, such as via parentheses or similar grouping indicators, and without requiring the user to be aware of the precedence of operations.

It is also an objective of the present invention to make available to users the simple and intuitive advantages of text searching when formulating queries. But another objective of the present invention is to give users a simple means of easily controlling the degree of vagueness and ambiguity inherent in text searching, to thereby limit over-inclusion as well as under-inclusion in the queries.

It is yet a further objective of the present invention to free users from the burden of having to formulate queries according to syntactic rules and conventions, and to eliminate the need for users to precisely enter the names of database elements, and the acceptable values thereof.

The use of data object collection subsets according to the present invention allows the above objectives to be met.

The subsets of the data object collection which make up query elements according to the present invention are defined by the user (or by a proxy for the user), and include, but are not limited to, subsets constructed by:

text searching;

performing existing queries;

selection according to formal data attributes assigned to the data objects; and

arbitrary inclusion in designated subsets, in order to emphasize and/or categorize ideas and concepts represented in the data objects.

Regarding the selection according to formal data attributes assigned to the data objects, it is evident that any data object (even a data object consisting principally of text, such as a document) can have a set of formal data attributes, and that these formal data attributes can be employed in a conventional manner to extract a subset of data objects from a larger data object collection. In a non-limiting example, a data object corresponding to a piece of music offered for sale might have a formal data attribute containing the sale price, in which case a subset could be extracted containing all the data objects with a sale price at or below a specified amount. As another non-limiting example, a data object that is a text document might have a formal data attribute containing a pointer to a template upon which the document's format is based, in which case a subset could be extracted containing all the data objects having a similar appearance or layout.

FIG. 3 is a Venn diagram of a data object collection 301, illustrating the use of subsets for formulating a query according to the present invention. The query illustrated in FIG. 3 is in some ways similar to the text-searching query example previously discussed, for retrieving data objects that reference both John Coltrane and Miles Davis, for the purpose of compiling a discography of jazz performances featuring these artists together. In this example, however, data object collection 301 is not limited to pages of the World-Wide Web, but is understood to be an instance of a more general class of data object collections. As a non-limiting example, data object collection 301 may include data objects that are stored locally by the user and which may not necessarily be accessible over a network. Recall that, as previously noted, in the prior art there are problems formulating a query that gives the desired results, because of the possibilities of under-inclusion and over-inclusion, both of which can occur simultaneously. FIG. 3 illustrates queries for subsets via text searching. A subset 303 includes retrieved data objects containing the text phrase “Davis”, a subset 305 includes retrieved data objects containing the phrase “Coltrane”, a subset 307 includes retrieved data objects containing the phrase “Miles”, and a subset 309 includes retrieved data objects containing the phrase “Trane”. The ability to retrieve such subsets via text searching and to combine them via regular set operations is, of course, well-known in the art, as is illustrated in a previous example. For instance, it is possible in the prior art to obtain the intersection of subset 303 and subset 305 to obtain all the data objects containing both the term “Coltrane” and the term “Davis”. But, as shown previously, there are limitations and deficiencies with such text-searching queries, because of the vagueness and ambiguity inherent in text searching.

The present invention, however, serves to overcome, at least partially, these deficiencies and limitations by providing special subsets of data object collection 301 which are not necessarily retrievable by text searching, and which may be combined using regular set operations to control the degree of vagueness and ambiguity of queries which involve text searching. For example, there is a [Jazz Musicians] subset 311 of data objects related to jazz musicians, which have been included therein because of meaning and content, rather than because of the occurrence of any particular words or phrases. Thus, subset 311 is not necessarily retrievable by text searching alone, even when aided by methods which involve meta-tags and evidence sets. As another example, it is clear that it could be an exceedingly difficult task to formulate a successful text searching query for retrieving data objects that refer to the prominent jazz saxophonist Charlie Parker by only his nickname “Bird”, because of the serious over-inclusion problem for a common term such as “bird”. The inclusion of data objects in subset 311 may be done by the user on a case-by-case basis. If an written article (a data object) about “Bird” (Charlie Parker) were contained in data object collection 301, then the user might elect to include this particular article in [Jazz Musicians] subset 311, by virtue of the fact that the article is a data object related to a jazz musician. In an embodiment of the present invention, such an inclusion would be done in a “manual” fashion, by allowing the user to create a [Jazz Musicians] arbitrary subset 311 dedicated to the topic of jazz musicians, and later manually designating the Charlie Parker “Bird” article for inclusion in [Jazz Musicians] subset 311 in an arbitrary fashion. The term “arbitrary”, as in “Arbitrary subset”, herein refers to the fact that the user is free to include or exclude a particular data object with respect to the subset without being limited by any formal rules. For such a subset to be effective, however, it is desirable that the data objects included therein be related in meaning and/or content to a designated topic associated with the subset, and in this regard the inclusion or exclusion of a data object with respect to the subset is not completely “arbitrary” in the most general sense of the word. In the above example, including the Charlie Parker “Bird” article in subset 311 is “arbitrary” in that the article is elected by the user for inclusion on the basis of relevant meaning and content rather than on the basis of any formal mathematical rule. It would clearly be technically feasible for the user also to “arbitrarily” include an article on “bird watching” in subset 311, but doing so would undermine the effectiveness of subset 311 for the intended purpose because such an article does not correspond to the meaning and content designated for subset 311, and thus the term “arbitrary” as used herein does not extend to such an action.

To improve clarity in the examples and illustrations herein, words and phrases for text searching are delimited within double quotes (as in “John Coltrane”), whereas the identifying names of subsets (including, but not limited to subsets retrieved by a query, as well as arbitrary subsets) are delimited within square brackets (as in [Jazz Musicians]).

In another embodiment of the present invention, the user could obtain [Jazz Musicians] subset 311 from an outside source. In either case, and regardless of whether subset 311 is stored locally in a computer controlled by the user, or remotely over a network, it is important to note that subset 311 and the contents thereof are under the arbitrary control of the user. The user may elect to arbitrarily add data objects to subset 311 or arbitrarily remove data objects therefrom.

In an embodiment of the present invention, a subset (such as subset 311) is an explicit subset—that is, subset 311 is itself a data object collection containing a set of data objects (in this example, all related to jazz musicians, and all of which also happen to be contained within data object collection 301). The term “explicit”, as in “explicit subset” herein denotes such a subset which is itself a data object collection. This is in contrast to the situation of an implicit subset of data object collection 301, which can be formed, for example, merely by attaching a meta-tag containing a “key word” or “key phrase” to selected data objects. The term “implicit”, as in “implicit subset” herein denotes information (including, but not limited to, meta-tags and formal data attributes) by which it is possible to extract a desired subset of data objects from a data object collection, but wherein such information is not itself a pre-existing data object collection. In the case of a data object collection which is stored locally, there is no significant distinction between an explicit subset and an implicit subset, because an explicit subset can be easily and quickly constructed from the information of an implicit subset. However, for a data object collection which is stored remotely over, and/or which is distributed over, a network, there can be a great practical difference between these two kinds of subset, because it may require an unreasonable amount of time to search the network for all the relevant data objects conforming to the information of the implicit subset and put those data objects into a data object collection to construct the corresponding explicit subset.

Subset 311 allows the user to control the vagueness and ambiguity of queries based on text searching to help solve the over-inclusion problem. In this example, the user would perform the intersection of subset 311, subset 303, and subset 305 to obtain all the data objects in data object collection 301 that contain both the term “Coltrane” and the term “Davis”, and which pertain to jazz musicians. Doing so thereby eliminates any unwanted references to Robbie Coltrane and Warwick Davis (since they are not jazz musicians and data objects referring to them would therefore not be included in subset 311). However, an incidental reference to one of these actors in an article about the jazz musicians would not exclude that article from retrieval. Thus, the use of subsets according to this embodiment of the present invention does not suffer from the previously-noted problem of under-inclusion by erroneous rejection.

Moreover, because in this example the user is interested in compiling a discography of jazz performances featuring John Coltrane and Miles Davis together, it is possible to take the process further, by defining an explicit arbitrary subset 313 containing data objects related to [Recorded Performances]. Subset 313 is not necessarily limited to data objects which themselves contain actual recordings of performances, but also includes data objects that are merely related to recorded performances, such as listings or references to recorded performances. Furthermore, subset 313 is not limited to data objects related to jazz performances, nor even to recorded musical performances, but could also include data objects related to recorded performances of any kind. (Of course, other subsets can be created that would conform to each of these categories, or various combinations thereof) By performing the intersection of subset 313, subset 311, subset 303, and subset 305, the user can obtain all the data objects in data object collection 301 that contain both the term “Coltrane” and the term “Davis ”, which pertain to jazz musicians, and which pertain to recorded performances. This intersection is shown in FIG. 3 as a subset 315 that contains information that is highly relevant to the desired discography. It is noted that a separate subset 317 contains data objects that contain both the term “Coltrane” and the term “Davis”, but which are not of interest to the user (e.g., which do not relate to jazz musicians, such as by relating instead to Robbie Coltrane and Warwick Davis, or which do not relate to recorded performances, etc.).

Likewise, subset 307 and 309 can be utilized to include data objects in which the phrase “Trane” and “Miles” occur.

### Keywords vs. Arbitrary Subsets

Regarding the arbitrary inclusion of data objects in designated subsets in order to emphasize and/or categorize ideas and concepts represented in the data objects, it is noted that a similar purpose is behind the placement of so-called “keywords” (also known by similar terms, such as “key words” and “key phrases”) in certain data objects, particularly those containing text. The keywords are often assigned to a formal data attribute associated with the data object (including, but not limited to, meta-tags in HTML). In this manner, it is possible to select the data object based on ideas and concepts represented thereby, via formal database operations that test the keywords formal data attribute for those ideas and concepts. For example, a review (a text document) of a recording featuring a saxophone solo by John Coltrane might be tagged with the keywords “jazz musician” and “recorded performance”. A keyword does not necessarily have to appear within the normally-readable text of the data object, and therefore keywords can be assigned arbitrarily to cover many possible ideas or concepts represented by the data object. Because of the ability of keywords to express arbitrary ideas and concepts independent of the text contained within a data object, and because of the ability for automated selection via formal database operations on keywords, it might seem that searching the data object collection for data objects having both keywords “jazz musician” and “recorded performance” is functionally-equivalent to performing an intersection of arbitrary subset 311 [Jazz Musicians] with arbitrary subset 313 [Recorded Performances], as described above and illustrated in FIG. 3. There are, however, several noteworthy limitations with the use of keywords, which are overcome by the use of arbitrary subsets according to embodiments of the present invention. First, keywords must be inserted into the data objects, either by the author of the data object at the time of creation, or afterwards by someone having access to the formal data attributes of the data object, and this requires a modification of the data object, which may not be practical or feasible after creation. Second, because keywords are a property of a data object themselves, the association of the data object with ideas and concepts will be the same for every user. Not every user, however, will necessarily consider that the data object represents the same ideas and concepts. Accommodating diverse user interpretations of a data object by associating additional ideas or concepts that were not previously recognized requires that the data object be subject to continual modification, and this may cause problems to arise regarding inconsistencies in different versions of the data object. Third, the set of all keywords of a data object collection is not immediately visible to the users and authors of data objects, and may in fact be a very large set. The lack of visibility results in the likelihood that similar ideas or concepts are represented by different keywords. For example, whereas one author of a data object might choose the keyword “jazz musician” to attach to the data object, another author might choose a pair of keywords such as “jazz” and “musical artist” to attach to a different data object, even though these different keyword choices represent the same idea or concept. This results in confusion and under-inclusion, requiring artifices such as evidence sets to unify these diverse representations.

In contrast, however, the use of arbitrary subsets to represent ideas or concepts according to the present invention does not suffer from any of the above limitations. First, the inclusion of a data object within an arbitrary subset does not require any modification of the data object itself. Second, the inclusion of a data object within an arbitrary subset is not a property of the data object, so that different users can associate that data object with different ideas and concepts. And third, the arbitrary subsets are highly visible to authors and users, facilitating uniformity in the way ideas and concepts are represented, and eliminating the need for evidence sets to reduce under-inclusion.

### Reducing Over-Inclusion

It is noted that utilizing arbitrary subset in the manner described reduces, but does not entirely eliminate all of the vagueness and ambiguity inherent in text searching. However, by reducing the amount of over-inclusion, the volume of the query results can be brought down to a manageable level, where individual human consideration becomes feasible. As previously noted, over-inclusive text-searching queries can result in hundreds of thousands of extraneous data objects. Through the use of subsets according to the present invention, the majority of unwanted data objects can be eliminated, thus rendering the resulting subset of data objects amenable to manual adjustment to eliminate unwanted data objects and/or to include wanted data objects that may not have been found by the text-searching query. Such manual adjustment of the findings of text searching, moreover, can result in an additional useful arbitrary subset.

It has already been noted that subset 311 is unlikely to result from text searching alone. Moreover, the user may not be able to locate a suitable vortal having the particular desired topics. Even if there were such a vortal dedicated to jazz musicians, however, the vortal's value to the user would be in independently assembling an explicit subset, such as subset 311, and then adding the contents of subset 311 to data object collection 301. The user would not be able to perform regular set operations on the vortal's contents with subsets of data objects that are outside the vortal.

In yet another embodiment of the present invention, queries are formulated by selecting subsets from lists presented to the user, which contain valid subsets, thereby automatically guaranteeing that every query a priori has correct element names and values. In a further embodiment of the present invention, queries are formulated such that the appropriate set operations are automatically specified by the manner in which selections are made from the lists. In such modes of formulation involving list selection, all queries are a priori valid, and the user need never be concerned about observing any rules of syntax. Instead, the user is free to concentrate on the semantic content of the query. Moreover, the mechanisms for implementing such queries are simplified, because the queries can be constructed as list selections are made without having to parse or interpret any “query language” statements.

The principles of the present invention are applicable to a traditional database, but are more effectively applied to more general data object collections, and are especially useful in formulating queries for use with “Internet-type” data object collections.

It will be appreciated that a system according to the present invention may be a suitably-programmed computer, and that methods of the present invention may be performed by a suitably-programmed computer. Thus, the invention contemplates a computer program product that is readable by a machine, such as a, computer, for emulating or effecting a system of the invention, or any part thereof, or for performing a method of the invention, or any part thereof The term “computer program” herein denotes any collection of data for commanding or controlling a computer or similar device. The term “computer program product” herein denotes any collection of machine-readable codes, and/or instructions, and/or data associated with and residing in machine-accessible data storage for: representing or implementing an arrangement of the invention, or any part thereof, emulating or effecting a system of the invention, or any part thereof, or performing a method of the invention, or any part thereof

Therefore, according to the present invention there is provided a query data structure in machine-accessible data storage for specifying machine-readable data objects to be retrieved from a data object collection, the query including a non-empty set of machine-readable selection rules, at least one of which contains a non-empty set of machine-readable selection terms, wherein: (a) each of the selection terms specifies a corresponding selection term subset of the data object collection; (b) each of the selection rules is of a type selected from the group consisting of inclusion selection rule type; and exclusion selection rule type; (c) each of the selection rules specifies a corresponding selection rule subset of the data object collection, wherein: for a selection rule of the inclusion selection rule type, the selection rule subset is the union of the selection term subsets corresponding to the selection terms contained in the selection rule; and for a selection rule of the exclusion selection rule type, the selection rule subset is the complement of the union of the selection term subsets corresponding to the selection terms contained in the selection rule; and (d) the query data structure specifies a query result subset of the data object collection, wherein the query result subset is the intersection of the selection rule subsets corresponding to the selection rules of the query.

In addition, according to the present invention there is provided a method for automatically evaluating a query by a data processing device and retrieving machine-readable data objects specified by the query from a data object collection, the query containing a non-empty set of machine-readable selection rules, at least one of which contains a non-empty set of machine-readable selection terms, wherein each selection rule is of a type selected from the group consisting of inclusion selection rule type and exclusion selection rule type, the method including: (a) providing storage for a query result subset; (b) providing storage for a selection rule result subset; (c) for each selection rule: determining the selection terms; for each selection term: determining a selection term result subset; replacing the selection rule result subset with the set union of the selection rule result subset and the selection term result subset; if the selection rule is of exclusion selection rule type, replacing the selection rule result subset with the complement of the selection rule subset; and (d) replacing the query result subset with the set intersection of the query result subset and the selection rule subset.

Moreover, according to the present invention there is provided a system for automatically evaluating a query and retrieving machine-readable data objects specified by the query from a data object collection, the query including a set of selection rules, each including a set of selection terms, the system including: (a) a selection rule extractor, for obtaining the selection rules of the query; (b) a selection rule evaluator, for obtaining a selection rule result subset of the data object collection; (c) a selection term extractor, for obtaining the selection terms of a selection rule; (d) a selection term evaluator, for obtaining a selection term result subset of the data object collection; (e) a union calculator, for producing the selection rule result subset in conjunction with the selection term extractor and the selection term evaluator, by calculating the set union of the selection term result subsets corresponding to the selection terms of a selection rule; and (f) an intersection calculator, for producing a query result subset of the data object collection in conjunction with the selection rule extractor and the selection rule evaluator, by calculating the set intersection of the selection rule result subsets corresponding to the selection rules of the query; (g) wherein the query result subset contains the machine-readable data objects specified by the query.

Furthermore, according to the present invention there is provided a data terminal user interface for enabling a user to construct a machine-readable query data structure for specifying data objects to be retrieved from a data object collection, the query data structure containing a set of machine-readable selection rules, each containing a set of machine-readable selection terms, the user interface including: (a) a presentation of selection rules, wherein the user can choose a selection rule therefrom; (b) a presentation of selection terms, wherein the user can choose a selection term therefrom; (c) a presentation of pre-existing subsets of the data object collection; and (d) a cursor; wherein the user can choose a pre-existing subset for constructing a selection term and a selection term for constructing a selection rule of the query data structure under construction.

### BRIEF DESCRIPTION OF THE DRAWINGS

The invention is herein described, by way of example only, with reference to the accompanying drawings, wherein:

FIG. 1 conceptually depicts the components of an exemplary prior art formal database.

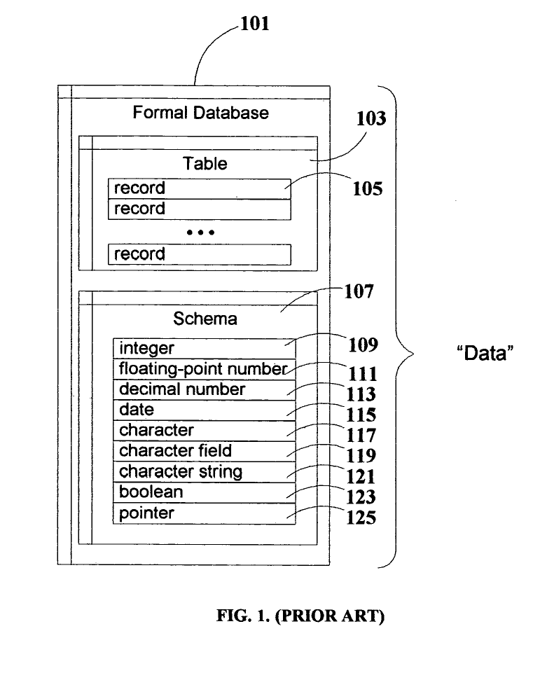

FIG. 2 conceptually depicts the components of an exemplary prior art generalized data object collection.

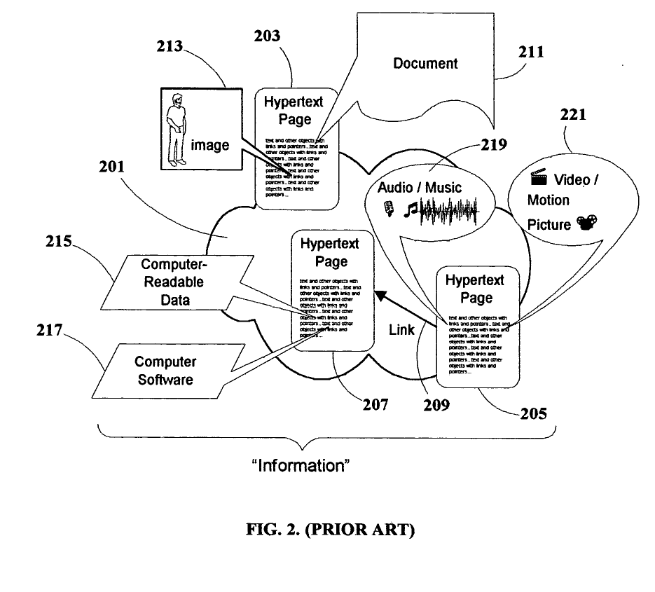

FIG. 3 is a Venn diagram showing an example of how explicit subsets according to the present invention may be manipulated to form a query.

FIG. 4 illustrates a general example of the structure of a query according to an embodiment of the present invention.

FIG. 5 illustrates the structure of a query according to an embodiment of the present invention corresponding to the example of FIG. 3.

FIG. 6 illustrates the composition of a general user interface according to embodiments of the present invention.

FIG. 7 shows a basic graphical user interface screen for choosing query selection rules according to an embodiment of the present invention.

FIG. 8 shows the basic graphical user interface screen of FIG. 7 with a first selection rule chosen.

FIG. 9 shows the basic graphical user interface screen of FIG. 7 with a second selection rule chosen.

FIG. 10 shows the basic graphical user interface screen of FIG. 7 with a third selection rule chosen.

FIG. 11 shows the basic graphical user interface screen of FIG. 7 with a fourth selection rule chosen.

FIG. 12 is a flowchart illustrating a method according to an embodiment of the present invention for evaluating a query.

FIG. 13 is a block diagram illustrating a system according to an embodiment of the present invention for evaluating a query.

### DESCRIPTION OF THE PREFERRED EMBODIMENTS

The principles and operation of embodiments of the present invention, for specifying the selection of data objects to be retrieved from a collection, may be understood with reference to the drawings and the accompanying description.

### Query Structure

In a preferred embodiment of the present invention, a machine-readable query has a specific formal structure which facilitates user formulation and comprehension, and also improves the efficiency of interfacing with the user and internally interpreting the query to perform the desired query action. Such a query contains at least one machine-readable selection rule, and each selection rule of the query contains at least one machine-readable selection term. That is, queries are subdivided into selection rules, and selection rules are subdivided into selection terms. Multiple selection terms within a selection rule operate on one another by the set union operator (∪) to produce the effect of the selection rule; and multiple selection rules operate on one another by the set intersection operator (∩) to produce the effect of the query. Moreover, in a preferred embodiment of the present invention, the set complement operator (′) may also be applied to a selection rule. Machine-readable queries, selection rules, and selection terms are stored in machine-accessible form, for example as in machine memory, storage media, or in a data network, for automated processing.

It is noted that there are many different and equivalent ways of specifying the results of a query, and that the results of a query structured according to embodiments of the present invention may also be specified by prior art query representations. Consequently, it is emphasized that embodiments of the present invention relate to the explicit formal structuring of queries based on selection rules, selection terms, and set operations as specified herein in such a manner that there exist machine-readable data objects corresponding thereto, and in such a manner that the selection rules, selection terms, and set operations are potentially visible as such to the user during the formulation of queries.

It is noted that for compactness and ease of reading, the drawings employ the single word “rule” to denote a selection rule or “rules” to denote selection rules, and employ the single word “term” to denote a selection term.

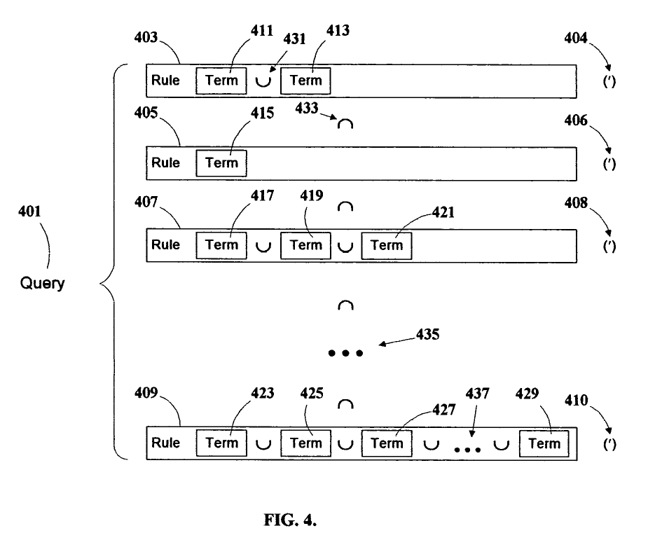

FIG. 4 illustrates a general example of the structure of query 401, which is shown containing a selection rule 403, a selection rule 405, a selection rule 407, and a selection rule 409. An intersection operator (∩) 433 indicates that the results of the query is the set intersection of the results of all the selection rules. An ellipsis 435 indicates that additional selection rules may be inserted in query 401. Selection rule 403 is shown containing two selection terms, a selection term 411 and a selection term 413. A union operator (∪) 431 indicates that the results of the selection rule is the set union of the results of all the selection terms of that selection rule. Selection rule 405 is shown containing a single selection term 415, and selection rule 407 is shown containing three selection terms: a selection term 417, a selection term 419, and a selection term 421. Selection rule 409 is shown containing a selection term 423, a selection term 425, a selection term 427, and a selection term 429. An ellipsis 437 indicates that additional selection terms may be inserted in selection rule 409.

A selection rule may be specified to be the set union (∪) of the selection terms therein (an inclusion selection rule) or the complement (in the data object collection) of the set union of the selection terms therein (an exclusion selection rule). A selection rule conforming to the former condition is denoted herein as an “inclusion selection rule” because only data objects included in the set union of the selection terms are included in the query results. A selection rule conforming to the latter condition is denoted herein as an “exclusion selection rule” because any data object included in the set union of the selection terms is excluded from the query results. The complement of a subset is often denoted in traditional set theory by placing a prime sign (′) afterwards. For example, the complement of a subset s is often written as s′. In cases where a selection rule is an exclusion selection rule, the complement is taken, as denoted by a sign 404, a sign 406, a sign 408, and a sign 410, which are applied in the case where the respective selection rule is an exclusion selection rule.

It is noted that a novel feature of a query according to an embodiment of the present invention involves explicit intersections of pre-defined existing subsets of a data object collection to effect the application of multiple selection rules, as illustrated in FIG. 4. Whereas in the prior art, the Boolean AND operation specifies the same effect, Boolean operators in the prior art are applied individually on the data objects, rather than on pre-defined existing subsets as provided by queries according to the present invention.

Selection terms, in effect, constitute the “atoms” of the query. A selection term contains a single criterion that can be used to obtain a subset of the data object collection in which the query operates. A selection term can be any one of the following:

1. a text-searching query for a single word or phrase;

2. a specified existing arbitrary subset of the data object collection;

3. a mathematical expression on one or more existing formal data attributes of the data objects, evaluating to a Boolean value from which a subset of the data object collection may be constructed; or

4. a specified existing query.

The above may be considered selection term “types”.

As noted earlier, a selection rule may be specified to be the set union (∪) of the selection terms therein (an inclusion selection rule) or the complement (in the data object collection) of the set union of the selection terms therein (an exclusion selection rule). A selection rule conforming to the former condition is denoted herein as an “inclusion selection rule” because only data objects included in the set union of the selection terms are included in the query results. A selection rule conforming to the latter condition is denoted herein as an “exclusion selection rule” because any data object included in the set union of the selection terms is excluded from the query results. Both the inclusion selection rule and the exclusion selection rule may be regarded as selection rule “types”.

It is noted that, mathematically, the set operations of union and intersection are both distributive and commutative, so that neither the order of their operands nor the order of their application affect the results.

It is moreover noted that because the union operator is a binary operator (having two operands), the following special convention is applied: In cases of a selection rule having only a single selection term, the union operator is construed to have an implied empty set (Ø) as a second operand. That is, for a selection rule r having only a single selection term t with a selection term subset sₜ, the selection rule subset sᵣ is given by:

sᵣ=sₜ∪Ø=sₜ for an inclusion selection rule; and

sᵣ=(sₜ)′∪Ø=(sₜ)′ for an exclusion selection rule.

Likewise, it is furthermore noted that because the intersection operator is also a binary operator, the following special convention is additionally applied: In cases of a query having only a single selection rule, the intersection operator is construed by implication to have the entire data object collection (the “universe” U) as a second operand. That is, for a query q having only a single selection rule r with a selection rule subset sᵣ, the query result subset s_{q} is given by:

s_{q}=sᵣ∩U=sᵣ

It is further noted that, as described above, a selection term may contain a reference to a specified existing query, and that there is thus the possibility of recursive query references. It is understood, however, that the construction of queries must be such to avoid the possibility of circular references. That is, a query may not reference itself, either directly or indirectly.

It is moreover noted that, for the purposes of simplifying the concepts underlying selection rules constructed according to the present invention, a mathematical expression referring to existing formal data attributes of the data objects that evaluates to a Boolean value from which a subset of the data object collection may be constructed is considered to be equivalent to an existing subset, provided that subsets of local accessors can be constructed thereby; and an existing query is also considered to be equivalent to an existing subset, provided that subsets of local accessors can be constructed therefrom.

Regarding a text-searching query (selection terms of type 1., as listed above), it is noted that the word or phrase is indivisible in the sense that the data objects in the subset corresponding to the selection term must contain the exact word or phrase, optionally subject to any “wildcard” characters contained therein. For example, if the selection term specifies a text search for the phrase “red fox”, then only data objects containing this exact phrase will be retrieved. The text searching will not retrieve data objects simply having the word “red” or the word “fox”, or even both together but not one immediately after the other in the proper sequential order. If, however, wildcards are supported and the selection term specifies a text search for the phrase “red fox”, then data objects having the phrase “red foxes” could also be retrieved. Furthermore, it is also optionally possible for the text searching to ignore any non-alphanumeric characters in the specified phrase. So, for example, multiple redundant spaces, line-feeds, and so forth, embedded in appearances of the phrase could optionally be ignored.

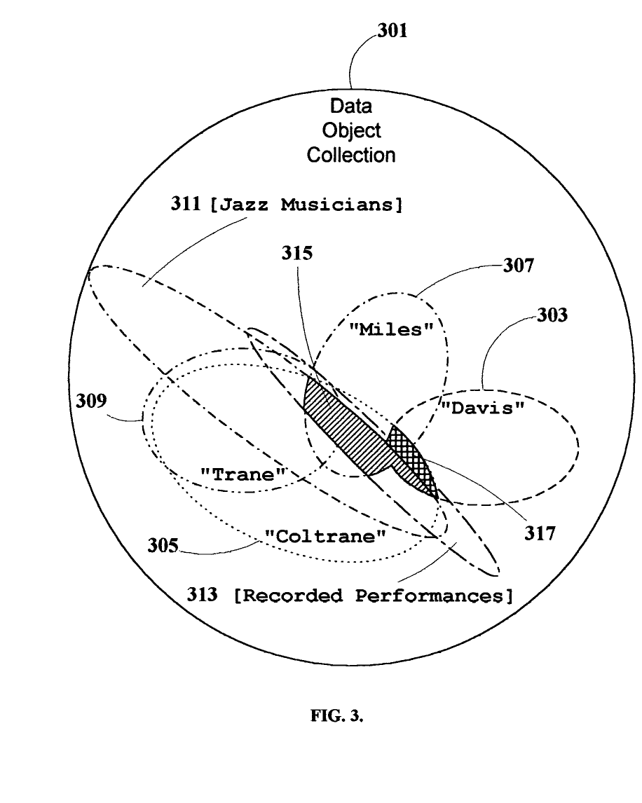

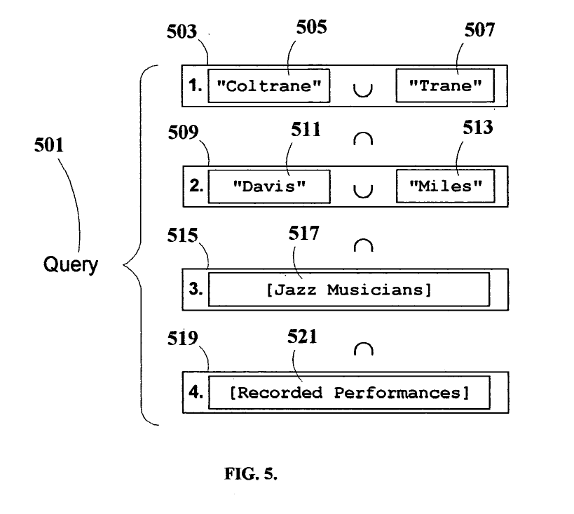

FIG. 5 illustrates a query 501 of the foregoing structure, which corresponds to the example discussed previously and illustrated in FIG. 3.

A first selection rule 503 contains a selection term 505 which specifies a text search for the word “Coltrane” (as results in subset 305 of FIG. 3), and a selection term 507 which specifies a text search for the word “Trane” (as results in subset 309 of FIG. 3). A second selection rule 509 contains a selection term 511 which specifies a text search for the word “Davis” (as results in subset 303 of FIG. 3), and a selection term 513 which specifies a text search for the word “Miles” (as results in subset 307 of FIG. 3). As illustrated in FIG. 4 and discussed previously for the general case, the result of selection rule 503 is the set union (∪) of the results of selection term 505 and the results of selection term 507. Likewise, the result of selection rule 509 is the set union of the results of selection term 511 and the results of selection term 513. A third selection rule 515 contains a single selection term 517, which specifies an arbitrary subset [Jazz Musicians] (as in subset 311 of FIG. 3). A fourth selection rule 519 contains a single selection term 521, which specifies an arbitrary subset [Recorded Performances] (as in subset 313 of FIG. 3). As illustrated in FIG. 4 and discussed previously for the general case, the result of query 501 is the set intersection (∩) of the results of selection rule 503, selection rule 509, selection rule 515, and selection rule 519.

The result of query 501, then, is a collection of data objects related to recorded performances featuring jazz musicians, wherein the data objects contain text references to “Coltrane” and/or “Trane” as well as text references to “Davis” and/or “Miles”. This reasonably specifies a collection of data objects that contains information related to recorded performances featuring both John Coltrane and Miles Davis, which a user could employ to assemble a discography of performances featuring both these artists together. Because at least part of query 501 still depends on text searching, the resulting collection of data objects is not guaranteed to be exhaustive, nor are all the data objects guaranteed to relate to the specific topic and be relevant to compiling the desired discography. That is, there is still the possibility of some vagueness and ambiguity. The amount of vagueness and ambiguity, however, is less than that of text searching alone.

### Expression, Representation, and Formulation of Queries

Query 501 may be expressed in conventional unstructured notation as:

(“Coltrane” OR “Trane”) AND (“Davis” OR “Miles”) AND [Jazz Musicians] AND [Recorded Performances] Query (1)

where it is emphasized that, whereas “Coltrane”, “Trane”, “Davis”, and “Miles” refer to text searching, both [Jazz Musicians] and [Recorded Performances] refer to subsets (in this case, arbitrary subsets), as defined previously.

The conventional unstructured notation of Query (1) is fairly simple, but there are limitations when using such a notation. First, some user training, albeit minimal, is necessary for formulating a query in this fashion, and the user must devote some attention and effort into formulating the query in a syntactically-correct manner. If the user fails to formulate the query precisely according to the syntactic rules (such as by entering unbalanced parentheses, omitting a required operand, etc.), submitting the query will result in an error. Second, formulating Query (1) requires the user to know the precise names of the arbitrary subsets employed. If the user misspells the name of an arbitrary subset, the query cannot be evaluated and will result in an error. If the user enters the name of the wrong arbitrary subset by mistake, the query will run, but may return incorrect results. And third, a complex query in the form of Query (1) will be hard for the user to formulate and understand.

As mentioned in passing above, it is possible for a query to contain unbalanced parentheses, that is, an expression containing more right parentheses than left parentheses, or vice versa. It is emphasized that, in general, a query containing unbalanced parentheses is ambiguous, and the precise interpretation of such a query is not possible without additional information. For example, the query

(“Coltrane” OR “Trane” AND (“Davis” OR “Miles”) AND [Jazz Musicians] AND [Recorded Performances] Query (2)

has two left parentheses but only one right parenthesis. This discrepancy may be resolved by either adding another right parenthesis or by removing a left parenthesis. In general, however, there are several possible places to insert a right parenthesis, and several possible left parentheses that can be removed. Also in general, the query changes meaning, depending on which place is chosen for inserting a parenthesis, or which parenthesis is to be removed. Consequently, the ambiguity of unbalanced parentheses cannot be resolved automatically.

It is noted that prior art queries do not necessarily require the use of parentheses. If parentheses are omitted from prior art queries, however, it is necessary for the user to be aware of the precedence of operations. For example, the results of a query such as

“dogs” AND “cats” OR “mice” Query (3)

will, in general, depend on the precedence of the Boolean AND operation relative to the Boolean OR operation. Usually, the AND operation is arbitrarily given a higher precedence than the OR operation, in which case Query (3) is interpreted as

(“dogs” AND “cats”) OR “mice” Query (4)

If, however, the OR operation were given a higher precedence than the AND operation, Query (3) would be interpreted as

“dogs” AND (“cats” OR “mice”) Query (5)

where the results of Query (4) are not in general the same as those of Query (5). The parentheses-free simplicity of Query (3) is attractive and appealing, but in a prior-art query such as Query (3), omitting parentheses can be confusing and misleading to an inexperienced user.

The structured query of the present invention avoids the limitations discussed above for Query (1) and Query (2). FIG. 5 adequately expresses the structure of the query, but the graphical representation is cumbersome. In an embodiment of the present invention, an improved way of presenting the query in structured form is as follows:

“Coltrane”, “Trane”

& “Davis”, “Miles”

& [Jazz Musicians]

& [Recorded Performances] Query (6)

where each separate line of Query (6) represents the corresponding selection rule in FIG. 5. Furthermore, in Query (6) the comma (,) represents the set union operator (∪) and the ampersand (&) represents the set intersection operator (∩).

The commas (,) are required to separate different selection terms appearing on the same line (within the same selection rule), but the ampersands (&) in this representation are redundant, because the placing of each selection rule on a separate line of Query (6) automatically implies the application of the intersection operation on the selection rules. If, however, the ampersands are included in the representation, putting the selection rules on separate lines becomes unnecessary, because the ampersands delimit the selection rules. Thus, Query (6) can be unambiguously written:

“Coltrane”, “Trane” & “Davis”, “Miles” & [Jazz Musicians] & [Recorded Performances] Query (7)

It has been previously noted that a selection rule can specify the complement of the set union of the selection terms therein, corresponding to the NOT operation in conventional notation. As mentioned above, the complement of a subset is often denoted in traditional set theory by placing a prime sign (′) afterwards. For example, the complement of a subset s is often written as s′. In the notation of the present invention, however, the complement operation is represented, as in Query (6), by a tilde (˜) before the first selection term of a selection rule, and applies to the entire selection rulee where a tilde (˜) appears. For example, the query

“Coltrane”

& “Davis”

&˜ [Jazz Musicians]

& [Recorded Performances] Query (8)

retrieves data objects containing the text “Coltrane” and the text “Davis”, which are in the arbitrary subset [Recorded Performances] but which are not in the arbitrary subset [Jazz Musicians]. This would retrieve data objects related, for example, to the motion pictures (which are recorded performances) in which the actors Robbie Coltrane and Warwick Davis appear together.

The following points are noted:

(1) In the notation of Queries (6) through (8), there is no need for parentheses to group the expressions. In an embodiment of the present invention, except for the comma (,), ampersand (&), tilde (˜), double quotes (″), square brackets ([]), and spaces, all non-alphanumeric characters, including parentheses, are ignored. Thus, structuring queries according to the present invention eliminates the problem of unbalanced parentheses by eliminating the use of parentheses altogether.

(2) The query structure according to the present invention conforms to a natural human language pattern for specifying things in which sets of eligible alternatives are grouped together, and which then qualify one another by being connected with conjunctive phrases. For example, consider the English sentence:

“Ms. Smith collects antiques and bric-a-brac of china, pottery, and glass that are rare or unusual, and which either match the style of her house or have a high resale value.”

This exhibits a familiar pattern for specifying things that is quite common in everyday speech, writing, and thinking, and is readily understood without having to make a step-by-step logical analysis. (This pattern need not be restricted to a single sentence, but can extend over several sentences.) In the formalism of the present invention, a query specifying the objects Ms. Smith collects could look like this:

[antiques, bric-a-brac]

& [china], [pottery], [glass]

& [rare], [unusual]

& [match style], [high resale value] Query(9)

In Query (9), the sets of eligible alternatives (such as [china], [pottery], [glass]) are represented by selection rules (shown here on separate lines) containing selection terms of the eligible alternatives, whose union (comma-specified) makes up the subset that is the selection rule's outcome. The subsets thus specified by these selection rules are then intersected (ampersand-specified) to apply the intended qualifications. This example shows how the query structure according to the present invention is compatible with a natural human way of conceptualizing and structuring text-searching queries, because the very nature of text searching approximates natural human language constructs for specifying things.

(3) Expressions of embodiments of the present invention are semi-Boolean, in that not all valid Boolean expressions can be directly represented in a single query structure according to the present invention. For example, consider the following query (written in conventional notation):

(“Coltrane” AND “Trane”)

OR

(“Davis” AND “Miles”) Query (10)

Query (10) seeks data objects which contain both the text “Coltrane” and the text “Trane”, or which contain both the text “Davis” and the text “Miles”. This query cannot be directly represented in a single query of the present invention's formalism, because queries according to the present invention are only semi-Boolean and lack the means to directly specify a union (OR) of two intersections (AND). There is no loss of generality, however, because it is possible to indirectly formulate any full Boolean query in a manner according to the present invention, by defining intermediate subsets. In this example, this is done by formulating the queries [Trane Coltrane] and [Miles Davis] as follows:

[Trane Coltrane]:=

“Coltrane”

& “Trane” Query (11)

[Miles Davis]:=

“Davis”

& “Miles” Query (12)

and hence Query (10) can be indirectly represented in terms of Query (11) and Query (12) as

[Trane Coltrane],

[Miles Davis] Query (13)

where Queries (11), (12), and (13) are all expressed according to the formalism of an embodiment of the present invention. In a similar manner, a query can be formulated indirectly according to the present invention for any Boolean expression that cannot be represented directly.

(4) A query according to the present invention with only a single selection rule having only text-searching queries is equivalent to a conventional text-searching query having a simple set of text searches connected with the Boolean OR operation. Likewise, a query according to the present invention with multiple selection rules each of which has only a single text-searching selection term is equivalent to a conventional text-searching query having a simple set of text searches connected with the Boolean AND operation. In both of these cases, the corresponding conventional text-searching query is simple and straightforward, so the advantages of the present invention are found in either:

(a) the use of selection terms specifying selection other than by text-searching (including, but not limited to, the use of one or more arbitrary subsets); and/or

(b) a plurality of selection rules at least one of which includes a plurality of selection terms.

### Natural Human Language Expressions

It is noted, regarding point (2) above, that there are other patterns for specifying things in natural human language, besides the pattern exemplified by Query (6). For example, consider the English sentence “Mr. Jones wants to buy either a red convertible or a white sport-utility vehicle.” This also exhibits a familiar pattern for specifying things that is quite common in everyday speech, writing, and thinking, but which is different from the pattern discussed in point (2) above. Here, such a pattern would be represented (in conventional notation) as:

([red] AND [convertible])

OR

([white] AND [sport-utility vehicle]) Query (14)

As detailed previously, this cannot be directly represented in the formalism of the present invention. However, it is also noted that such constructions in natural human language tend to be based on the use of adjectival modifiers, so that, in a text search, this can often be specified (in conventional notation) as

“red convertible”

OR

“white sport-utility vehicle” Query (15)

which can be formulated as a query according to the present invention:

“red convertible”, “white sport-utility vehicle” Query (16)

It is furthermore noted that queries exemplified by Query (6) and Query (9) are more easily expressed in natural human language than are queries exemplified by Query (10), which rely on parentheses for a precise specification. Natural human language is structured around speech, where the logical grouping function performed by parentheses in written expressions must be accomplished in other ways, such as by carefully rearranging word order, by placing pauses at key positions in the stream of speech, by accenting critical words, by inflecting the voice to emphasize separation points between clauses, or through combinations of these techniques. In informal writing, this is often indicated with the use of typographical emphasis (such as italics) to highlight a critical word that would be vocally accented or strongly inflected. A query of the kind represented by Query (10), which features unions of subset intersections, is thus more awkward to formulate in natural human language than a query of the kind represented by Query (6) or Query (9), which feature intersections of subset unions. Natural human language patterns reflect human thinking patterns, so it can be inferred that unions of subset intersections are of less importance in human conceptualization than intersections of subset unions. Consequently, a query structure according to an embodiment of the present invention, which facilitates queries of the latter kind at the expense of queries of the former kind (which must be formulated indirectly, as detailed above), is highly advantageous in practice. At the same time, however, the query structure according to an embodiment of the present invention enables formulating queries featuring unions of subset intersections based on modifiers (such as adjectival expressions) of the kind represented by Query (14), Query (15), and Query (16). Thus, the present invention supports the most important classes of Boolean queries as far as natural human language and conceptualization processes are concerned. The foregoing comments and analysis are applicable at least throughout the English-speaking world, and would also apply where similarly-structured languages are spoken.

### User Interface with Automatic Query Formulation for Correct Syntax

In embodiments of the present invention, arbitrary subsets are selected by the user from lists of valid existing subsets and are automatically inserted in the query being formulated, thereby a priori guaranteeing correct syntax and specification of valid subsets and data objects. In addition, the user can perform text typing operations in a similar manner to input text searching commands. The lists are presented to the user, and the user inputs selections thereof and performs text typing, via a data terminal or similar device. Through the use of a data terminal user interface according to an embodiment of the present invention, the user can construct queries according to embodiments of the present invention that are guaranteed not to contain any syntax errors, and which are guaranteed to refer only to valid pre-existing subsets of the relevant data object collection. In this context, then, the term “automatic query formulation” denotes that the query under construction is automatically composed from user choices made through interaction with a user interface, so that the user does not need to be skilled in the formal syntax of the query.

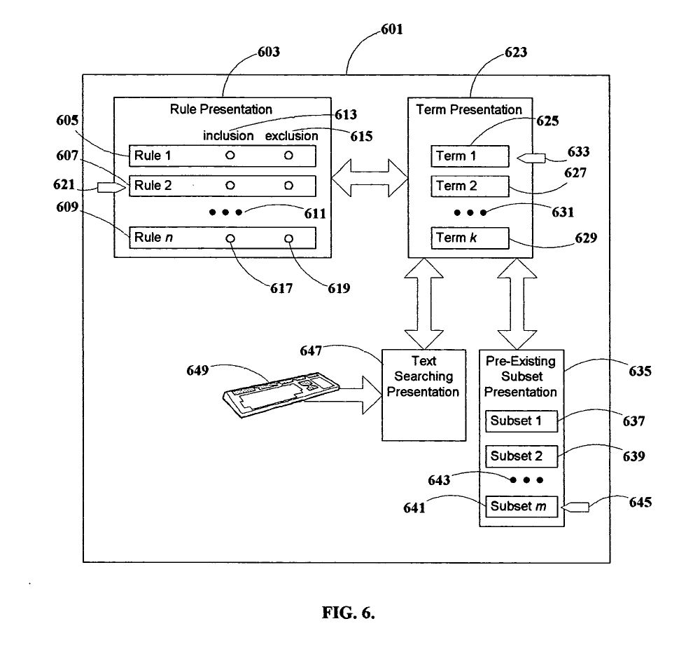

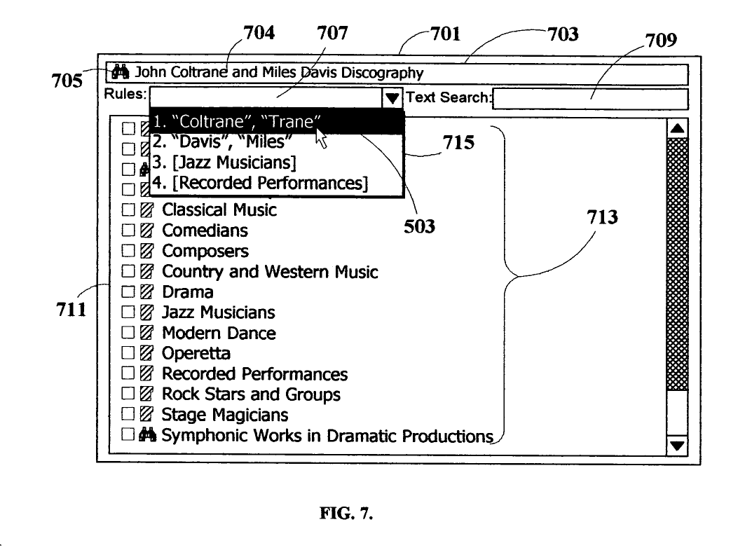

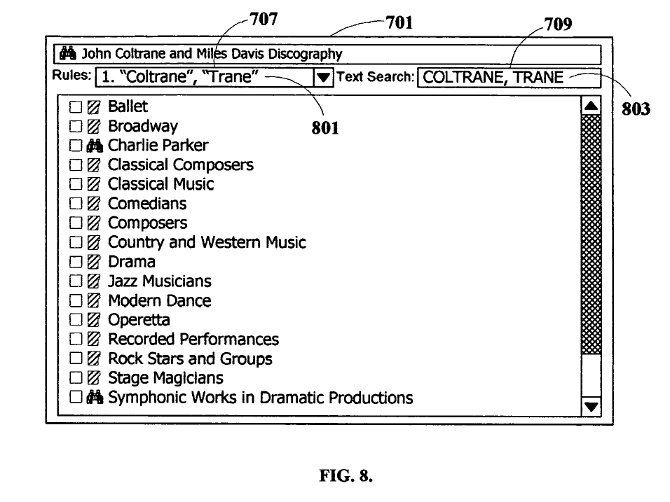

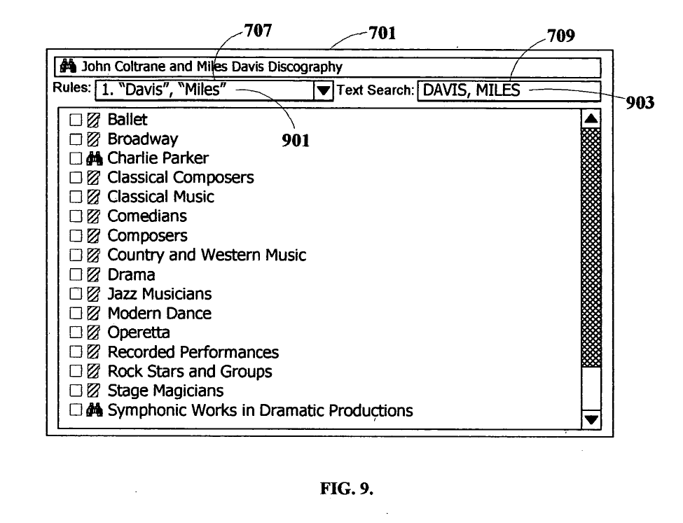

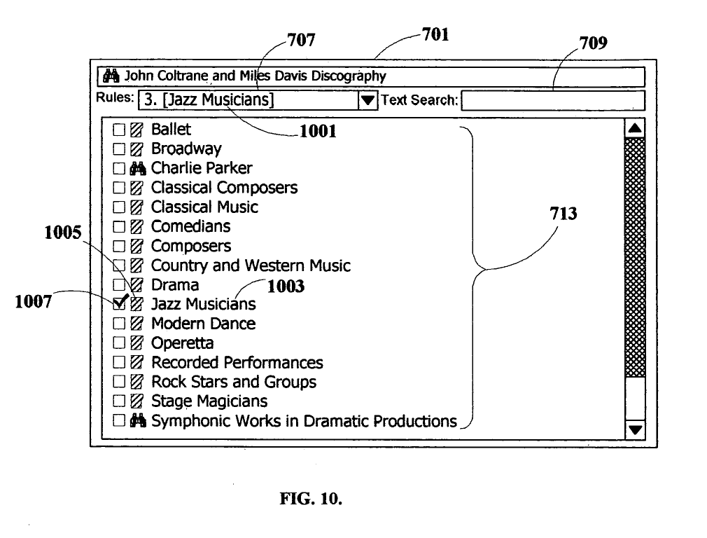

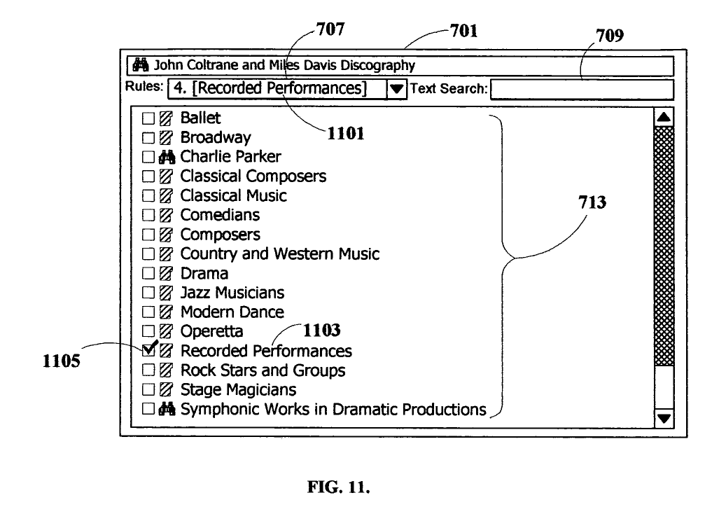

FIG. 6 illustrates the composition of a general user interface 601 for a data terminal, according to embodiments of the present invention. User interface 601 provides a selection rule presentation 603 of the selection rules contained in a query under construction. Presentation 603 contains a presentation 605 of selection rule 1 of the query under construction, a presentation 607 of selection rule 2 of the query under construction, and a presentation 609 of selection rule n of the query under construction. An ellipsis 611 indicates that there can be an arbitrary number of selection rules presented within presentation 603. An identifier 613 and an identifier 615 identify presentations of the selection rule type of the various selection rules, for inclusion selection rules and exclusion selection rules, respectively, corresponding to an indicator 617 and an indicator 619, as shown in presentation 609, but applicable to all presentations of the selection rules. A cursor 621 or other suitable indicator shows the particular selection rule presentation, if any, which has been chosen. As an example, FIG. 6 illustrates that selection rule 2, corresponding to presentation 607, has been chosen. A selection term presentation 623 shows the selection terms contained in the selection rule chosen from presentation 603. Presentation 623 contains a presentation 625 of selection term 1 of the chosen selection rule, a presentation 627 of selection term 2 of the chosen selection rule, and a presentation 629 of selection term k of the chosen selection rule. An ellipsis 631 indicates that there can be an arbitrary number of selection terms. A cursor 633 or other suitable indicator shows the particular selection term, if any, that has been chosen. As an example, FIG. 6 illustrates that selection term 1, corresponding to presentation 625, has been chosen. User interface 601 also provides a pre-existing subset presentation 635, which presents a subset 1 presentation 637, a subset 2 presentation 639, and a subset m presentation 641. An ellipsis 643 indicates that there may be an arbitrary number of pre-existing subsets. A cursor 645, or other suitable indicator shows the particular subset, if any, that has been chosen. As an example, FIG. 6 illustrates that subset m, corresponding to presentation 641, has been chosen. User interface 601 also provides a text searching presentation 647, which presents words and/or phrases that can be entered by text typing from an input device 649, a non-limiting example of which is a keyboard. It is noted that cursor 621, cursor 633, and cursor 645 need not be explicitly presented, but may be implicit in other features of user interface 601, as illustrated in FIG. 7, FIG. 8, FIG. 9, FIG. 10, and FIG. 11, and described below. Those show how the user may choose any particular selection term for example, through the use of other features of the user interface.

In principle, a user employs user interface 601 to construct a query by text typing via input device 649 and/or choosing a pre-existing subset via presentation 635 and cursor 645 to construct one or more selection terms, which are then presented by presentation 623. Available selection terms are assembled with the aid of cursor 633 to construct one or more selection rules, which are then presented by presentation 603.

The term “presentation” herein denotes any means of presenting information to the user. A non-limiting example of a presentation corresponding to presentation 603, presentation 623, and presentation 635 is a visual display screen displaying a selectable list. Non-limiting examples of presentation 647 include: a visual display screen displaying text; and an audio device reproducing or simulating human speech. It is further noted (as mentioned below), that a presentation may be iconic, and that manipulating or constructing data objects may be done via icons utilizing cursor operations, including, but not limited to “drag-and-drop” operations. The term “cursor” herein denotes any means of receiving input from the user for the purpose of making a choice from among presented items, including an indicator that may be controlled by the user through an input device, and which indicates a choice via the presentation. Non-limiting examples of a cursor include: a visual indicator controlled by a positioning device (including, but not limited to: trackball; mouse; joystick; or touch-sensitive surface) or keyboard; a stylus or touch-sensitive surface; and an audio alarm controlled by a microphone. The terms “construct”, “constructing”, “constructed”, and “construction” herein denote the process or result of creating a new query as well as modifying an existing query.

Detailed non-limiting examples of a user interface for a data terminal are presented in the drawings and descriptions below.

FIG. 7 illustrates a basic graphical user interface screen 701, which has a text entry control 703 for displaying an identifying title 704 for query 501 (FIG. 5), whose structure is being displayed for possible modification by the user. An icon 705 visually identifies this as a query. A drop-down selection control 707 contains a list 715 of the selection rules of query 501. A text entry control 709 allows display and entry of the words and phrases of selection rules containing text searching criteria, and a list control 711 contains a list 713 (only partially visible in FIG. 7) of the existing pre-defined subsets of the data object collection from which query 501 retrieves specified data objects. In FIG. 7, the user has previously caused the drop-down list of drop-down selection control 707 to become visible, and has positioned the cursor (pointer) over first selection rule 503 in list 715, which is consequently shown highlighted in reverse video mode, as may be done in a graphical user interface. By subsequently entering a selection command (such as by a suitable “mouse-click” or keystroke), the user can thereby select the currently-highlighted selection rule for display and optional modification.

FIG. 8 shows graphical user interface screen 701 after the user has chosen selection rule 503 from list 715 (FIG. 7). Drop-down selection control 707 now contains a reference 801 (1. “Coltrane”, “Trane”) to selection rule 503, and text entry control 709 now contains a text specification 803 for the two comma-separated text-searching selection terms of selection rule 503 (COLTRANE, TRANE), for the user to see and optionally edit. It is noted that text entry control 709 receives and displays text in all-uppercase (to emphasize to the user that the query is case-insensitive) and does not display or require as input the double-quotation marks which appear in selection rule reference 801 (the double-quotation marks are implied delimiters for the comma-separated words and phrases, and are omitted for easier entry and editing).

In a similar manner, FIG. 9 shows graphical user interface screen 701after the user has chosen selection rule 509 (FIG. 5) from list 715 (FIG. 7). Drop-down selection control 707 now contains a reference 901 (2. “Davis”, “Miles”) to selection rule 509, and text entry control 709 now contains a text specification 903 for the two comma-separated text-searching selection terms of selection rule 509 (DAVIS, MILES), for the user to see and optionally edit.

FIG. 10 shows graphical user interface screen 701after the user has chosen selection rule 515 (FIG. 5) from list 715 (FIG. 7). Drop-down selection control 707 now contains a reference 1001 (3. [Jazz Musicians]) to selection rule 515. Selection rule 515, however, has no text-searching selection terms, but rather specifies only arbitrary subset 311 (FIG. 3). Therefore, text entry control 709 is empty, and a Jazz Musicians reference 1003 is shown as selected in list 713. Reference 1003 can be shown as selected in a variety of ways in a graphical user interface. In FIG. 10 selection from list 913 is indicated visually by a checked check box 1007, but any other type of visual indication supported by graphical user interfaces is also possible, including, but not limited to: highlighting; color-change; reverse-video; underlining; font-change; and the placement or location of the reference. The user can de-select reference 1003, and/or select other references from list 713 to change the specification of selection rule 515. If, for example, the user were to select an additional reference from list 713, the subset corresponding to that reference would appear as an additional selection term in selection rule 515. In addition, the user can also enter text in text entry control 709 to specify one or more text-searching selection terms for selection rule 515. In this manner, the user can specify any combination of existing subset selection terms and/or text-searching selection terms for a selection rule. The set union of the various selected subset selection terms and text-searching selection terms would constitute the results of the selection rule, as previously described and as illustrated in FIG. 4. It is noted that, whereas text-searching selection terms are completely arbitrary, the user is constrained to choosing existing subset selection terms from list 713, and in this manner it is not possible for the user to make a syntactic mistake by, for example, misspelling the name of an existing subset or otherwise specifying a subset that does not exist. It is furthermore noted that reference 1003 is identified as a reference to an arbitrary subset by an icon 1005, and that all eligible existing subsets may be present in list 713, including existing queries, as identified by icon 705 (FIG. 7), which are capable of generating a subset and are therefore construed as equivalent to an existing subset, as previously discussed.

Likewise, FIG. 11 shows graphical user interface screen 701after the user has chosen selection rule 519 (FIG. 5) from list 715 (FIG. 7). Drop-down selection control 707 now contains a reference 1101 (4. [Recorded Performances]) to selection rule 519. Selection rule 519 also has no text-searching selection terms, and specifies only arbitrary subset 313 (FIG. 3). Therefore, text entry control 709 is empty, and a Recorded Performances reference 1103 is shown as selected in list 713 by a checked checkbox 1105.

The graphical user interface screen shown in FIG. 7, FIG. 8, FIG. 9, FIG. 10, and FIG. 11 is a basic screen for purposes of illustration only, to exhibit how the present invention provides for automatic formulation of queries to guarantee correct syntax and specification of valid subsets and data objects. It is understood that a screen for actual use in practice could feature, in addition to commands to accomplish the above-illustrated user functions, additional commands for: creating a new query; copying a query; deleting a query; adding new selection rules to the selected query; deleting unwanted selection rules from the selected query; re-ordering the selection rules of the selected query; changing attributes of the selected query; changing attributes of the chosen selection rule; changing a selection rule from being an inclusion selection rule to being an exclusion selection rule; changing a selection rule from being an exclusion selection rule to being an inclusion selection rule; for testing the operation of the selected query; for collecting the results of the selected query; for exiting the screen and saving any modifications that were made; and for exiting the screen and discarding any modifications that were made. The term “command” as used herein denotes any means by which a user can direct a computer to perform a specific function, as embodied in various interface features, including, but not limited to: controls; buttons; menus; menu choices; and keyboard shortcuts (or “accelerators”) or their equivalents. Furthermore, it is noted that the term “graphical user interface” herein denotes any user interface capable of displaying lists for user selection, including user interfaces that do not necessarily have all the capabilities as shown in FIG. 7, FIG. 8, FIG. 9, FIG. 10, and FIG. 11.

Moreover, it is possible to use other graphical properties of a graphical user interface to portray data objects and subsets, and to allow the user to manipulate data objects and subsets. For example, it is possible to represent data objects, subsets, queries, and so forth, in iconic form and allow the user to manipulate them via “drag-and-drop” operations. The various presentations illustrated in FIG. 6 and other drawings, and the operations thereupon are understood to also encompass such iconic representations and “drag-and-drop” operations as well.

In an embodiment of the present invention, the only items entered by the user via text typing are words and phrases, and subset selection is not done via text typing, but only via selection from lists, as detailed above. All words and phrases are a priori considered valid. Even nonsense and gibberish are considered valid, because such combinations may correspond to valid sequences of part numbers or other character strings which occur in data objects. Data object collections corresponding to the allowable selection terms of a selection rule (as enumerated previously) are entered by selection from a list presented to the user.

It is noted that there do exist in the prior art certain user interfaces which enable users to construct prior-art queries having a priori correct syntax. For example, user interfaces for many popular Internet search engines contain graphical interface features which allow the user to automatically build a query with sets of words and the ability to select options such as “all of these words”, “this exact phrase”, “any of these words”, and “none of these words”. These prior-art interfaces, however, cannot in general build a query corresponding to the structure of the embodiments of the present invention. For example, such an interface cannot build a query comparable to Query (16) without modification that would introduce a level of complexity that would defeat the purpose of making a simple query builder. Moreover, such prior-art interfaces are restricted to building text-searching queries only, and cannot be modified to build a query comparable to Query (7).

### Method for Automatically Evaluating Queries

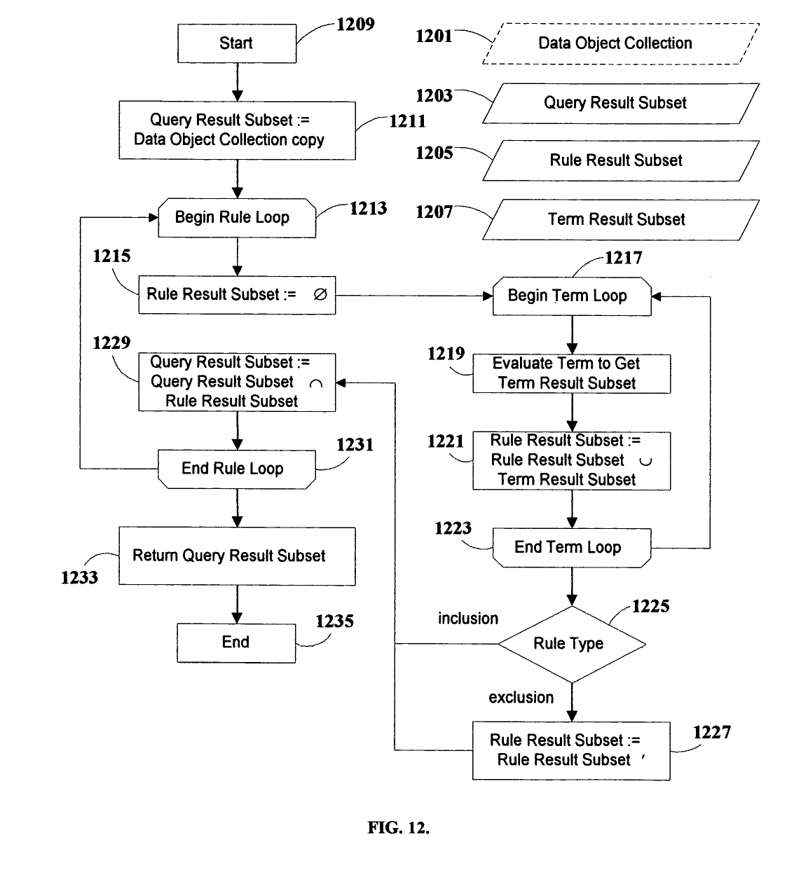

FIG. 12 is a flowchart illustrating a method according to an embodiment of the present invention for automatically evaluating a query by a data processing device. Associated with this method are a data object collection 1201 to be searched for the data objects to be retrieved; local storage for a query result subset 1203, in which the data objects retrieved according to the query will be placed; local storage for a selection rule result subset 1205, in which temporary results are accumulated during the evaluation of selection rules; and local storage for a selection term result subset 1207, in which temporary results are accumulated during the evaluation of a selection term.

It is noted that automatic manipulation of sets of data objects and the contained data objects themselves is well-known in the art. Certain computer languages contain explicit references to sets. The object-oriented Smalltalk language, for example, has traditionally implemented classes such as Collection and Set. It is well-known how these classes and their subclasses can readily be extended with specialized methods and further subclasses for additional set operations if desired.

FIG. 12 processing is as follows: Commencing after a starting point 1209, a step 1211 is executed, whereby data object collection 1201 is copied into the local storage for query result subset 1203. Then, the method begins looping through the selection rules of the query at a begin selection rule loop point 1213. For each selection rule, the first action is to empty the local storage for selection rule result subset 1205 at a point 1215 (the empty, or null, set is traditionally denoted by the symbol Ø).

Then, the method determines the selection terms of the selection rule and begins sub-looping through those selection terms at a begin selection term loop point 1217. At a point 1219 each selection term is evaluated to put the selection term result into the local storage for selection term result subset 1207. It is noted that the precise means of evaluating a selection term at point 1219 depends on the nature of the selection term, as previously discussed. For a selection term that represents the results of a text-searching query, evaluating the selection term involves running the specified text-searching query. Likewise, for a selection term that represents the results of an existing query, evaluating the selection term involves recursively running the specified query (using the present method). For a selection term that represents a Boolean expression referring to existing formal data attributes of the data objects in data object collection 1201, evaluating the selection term involves searching through the data object collection to find data objects for which the expression is true. For a selection term that represents a specified existing arbitrary subset of the data object collection, evaluating the selection term simply involves copying the specified arbitrary subset into the local storage for selection term result subset 1207. After each evaluation of a selection term, a step 1221 replaces the contents of selection rule result subset 1205 with the union of selection rule result subset 1205 and selection term result subset 1207. It is noted that prior to when the first selection term in the loop is evaluated, selection rule result subset 1205 had just been initialized to an empty set (Ø), so after the first selection term in the loop is evaluated, selection rule result subset 1205 will contain the results of the first selection term. If it should happen that the selection rule is empty (and thus has no selection terms), selection rule result subset 1205 will remain empty at the completion of the loop at an end selection term loop point 1223.

If there are further selection terms in the selection rule, end selection term loop point 1223 returns to begin selection term loop point 1217, and the loop is repeated until all selection terms of the selection rule have been processed.

After all the selection terms of the selection rule are processed, end selection term loop point 1223 continues to a decision point 1225, at which the type of selection rule is examined. If, and only if, the selection rule is an exclusion selection rule (as previously defined), then in a step 1227, the local storage for selection rule result subset 1205 is replaced with the complement (denoted by the ′ operator) of the contents. After decision point 1225, the selection rule has been evaluated, with the results in selection rule result subset 1205.

After each evaluation of a selection rule, a step 1229 replaces the contents of query result subset 1203 with the intersection of query result subset 1203 and selection rule result subset 1205. It is noted that prior to when the first selection rule in the loop is evaluated, query result subset had just been initialized to the entire data object collection, so after the first selection rule in the loop is evaluated, query result subset 1203 contains the results of the first selection rule. If it should happen that the query is empty (and thus has no selection rules), query result subset 1203 will still contain the entire data object collection 1201 at the completion of the loop at an end selection rule loop point 1231. If, on the other hand, there are selection rules, but at least one of the selection rules is an empty inclusion selection rule, then query result subset 1203 will be empty.

In any case, after end selection rule loop 1231, the method concludes by returning query result subset 1203 at a point 1233, and then terminates at an end point 1235. The results of the query are contained in query result subset 1203.

### System for Evaluating Queries

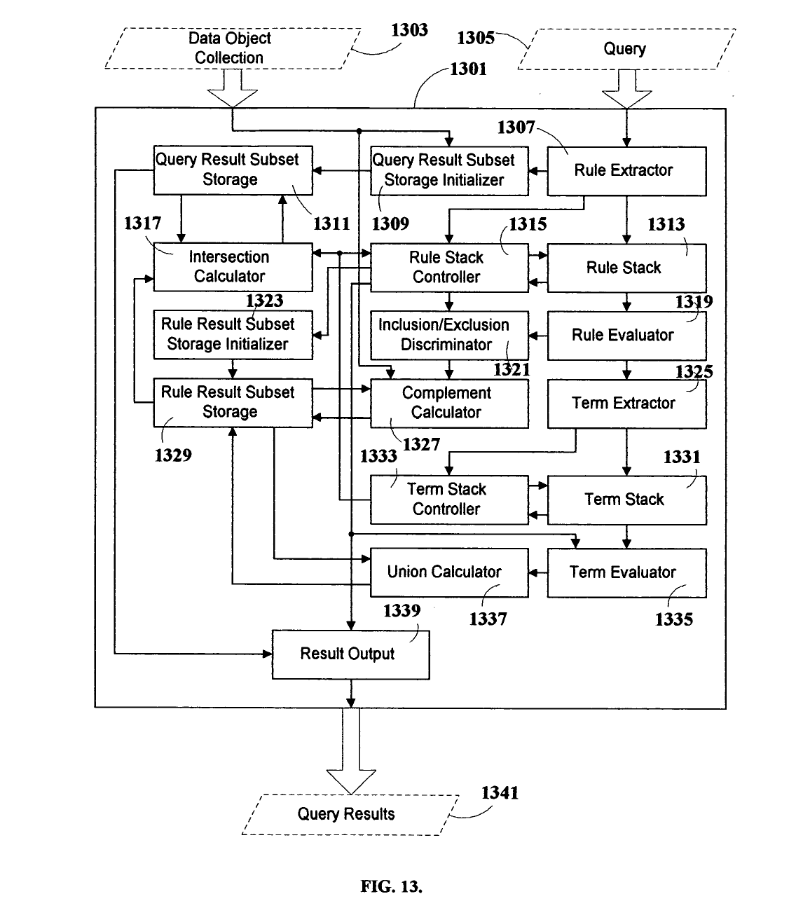

FIG. 13 is a block diagram illustrating a system 1301 according to an embodiment of the present invention for evaluating a query. Inputs to system 1301 are a data object collection 1303 and a query 1305. Upon input of query 1305, a selection rule extractor 1307 gets the selection rules of query 1305 and puts the selection rules in a selection rule stack 1313. The term “stack” herein denotes any data storage configuration which is capable of receiving and storing an arbitrary number of separate data objects, and subsequently delivering these data objects individually on demand to an output, where the demand does not need to specify which data object is to be delivered. A stack may be implemented in a number of ways, including, but not limited to: stack memory; heap memory; and arrays.

Next, selection rule extractor 1307 notifies a query result subset storage initializer 1309 to initialize a query result subset storage area 1311 with a copy of data object collection 1303. It is noted that a copy can be made by putting local accessors for the data objects in data object collection 1303 into query result subset storage 1311, as previously discussed regarding local accessors and their use. When selection rule extractor 1307 completes the extraction of selection rules into selection rule stack 1313, a selection rule stack controller 1315 is signaled to begin processing the selection rules, by sending each selection rule in sequence to a selection rule evaluator 1319. It is noted that selection rule stack controller 1315 also enables an inclusion/exclusion discriminator 1321. In case the selection rule being evaluated by selection rule evaluator 1319 is an exclusion selection rule, inclusion/exclusion 1321 discriminator sends a signal to a complement calculator 1327, which replaces the contents of a selection rule result subset storage area 1329 with the complement of the original contents, based on the contents of data object collection 1303.

When selection rule stack controller 1315 signals selection rule stack 1313 to send the next selection rule to selection rule evaluator 1319, a signal is also sent to a selection rule result subset initializer 1323 to initialize selection rule result storage area 1329 with an empty collection. When selection rule evaluator 1319 receives a selection rule, a selection term extractor 1325 extracts the selection terms of the selection rule being evaluated into a selection term stack 1331, which is controlled by a selection term stack controller 1333. When selection term extractor 1325 completes the extraction of all selection terms in the selection rule, a signal is sent to selection term stack controller 1333 to begin controlling selection term stack 1331 to send each selection term in sequence to a selection term evaluator 1335. Selection term evaluator 1335 evaluates a selection term by computing a subset of data object collection 1303 representing the data objects specified by the selection term. This subset is sent to a union calculator 1337, which then replaces the selection rule result subset in selection rule result subset storage 1329 with the union of the selection rule result subset in selection rule result subset storage 1329 and the computed selection term results from selection term evaluator 1335. In this manner, by the end of the processing of each selection term of the selection rule, the selection rule result subset in selection rule result subset storage area 1329 will contain the union of all the results of the selection terms of the selection rule. When the processing of a selection rule is completed, an intersection calculator 1317 replaces the query result subset in query result subset storage area 1311 with the intersection of the query result subset in query result subset storage area 1311 and the selection rule result subset in selection rule result subset storage area 1329. Thus, when all the selection rules of query 1305 have been processed, the query result subset in query result subset storage area 1311 will contain the intersection of all the selection rules, wherein each selection rule represents the union of all the selection terms of the selection rule, as is provided by the present invention. It is noted that selection term stack controller 1333 is shown as signaling intersection calculator 1317 to perform the intersection calculation when selection term stack 1331 is empty, and that selection term stack controller 1333 is shown as signaling selection rule stack controller 1315 to get the next selection rule upon this same condition of empty selection term stack 1331. As will be noted below, however, there are other equivalent control paths that can also perform this function.

When selection rule stack 1313 is empty, query 1305 has been completely processed, and a signal is sent to selection rule stack controller 1315, which then sends a signal to a result output 1339, which sends the contents of query result subset storage 1311 for output as query results 1341.

It is emphasized that, for both the method and system described above, there are many alternate and equivalent ways of accomplishing the desired operations. This is particularly evident when working with sets, because of the various mathematical identities in set operations. For example, it is well-known in the art that for any sets S and T, one of De Morgan's rules states that the following identity holds: (S∩T)′=S′∪T′. It is therefore possible to perform an intersection (S∩T) using the union and complement operations thus: (S′∪T)′. Therefore, the term “intersection calculator” (such as intersection calculator 1317 in FIG. 13) herein denotes any means for deriving a set which equals the intersection of a multiplicity of sets, regardless of the specific manner in which such a calculation is performed. Likewise, the term “union calculator” (such as union calculator 1337 in FIG. 13) herein denotes any means for deriving a set which equals the union of a multiplicity of sets, regardless of the specific manner in which such a calculation is performed; and the term “complement calculator” (such as complement calculator 1327 in FIG. 13) herein denotes any means for deriving a set which equals the complement of a set relative to another set, regardless of the specific manner in which such a calculation is performed. There are many variations on such operations, and therefore many different ways to implement the above method and system of the present invention. The various steps of the method, as illustrated in FIG. 12, and the various blocks of the system, as illustrated in FIG. 13, are therefore functional entities which can be implemented in many different ways. In particular, the blocks of FIG. 13 can be combined and/or subdivided into different configurations of operational blocks to accomplish the same effect. For example, the various controllers can be embodied within other blocks, and the various stacks can be embodied in a number of different memory constructs besides traditional “stacks”. Furthermore, in an object-oriented implementation of an embodiment of the present invention, it is well-known in the art that “objects” possess inherent “methods” which specify their dynamic behavior. Thus, for example, both selection term stack 1331 and selection term stack controller 1333 can exist within the same object, rather than being implemented separately as represented in FIG. 13. This is likewise the case for the other entities of FIG. 13 as well.

In addition, the precise path of logic flow can be altered in equivalent ways. For example, above it is stated that selection rule extractor 1307 notifies a query result subset storage initializer 1309 to initialize a query result subset storage area 1311 with a copy of data object collection 1303. It is also possible, however, for selection rule stack controller 1315 to notify query result subset storage initializer 1309. Likewise, FIG. 13 shows selection rule stack controller 1315 as signaling result output 1339 to output query results 1341 when selection rule stack 1313 is empty. It is also possible for selection rule stack 1313 to signal result output 1339 directly when empty. The control flow illustrated and described herein is thus exemplary and for purposes of illustration only, because different control paths can be used to accomplish the same results.

Moreover, it is also possible for a suitably-programmed computer to perform the method, and it is likewise possible to for a suitably-programmed computer to act as the system, by a straightforward implementation of the different blocks of FIG. 13.

While the invention has been described with respect to a limited number of embodiments, it will be appreciated that many variations, modifications and other applications of the invention may be made.

1. A query data structure in machine-accessible data storage for specifying machine-readable data objects to be retrieved from a data object collection, the query comprising a non-empty set of machine-readable selection rules, at least one of which contains a non-empty set of machine-readable selection terms, wherein:
(a) each of said selection terms specifies a corresponding selection term subset of the data object collection;
(b) each of said selection rules is of a type selected from the group consisting of:
i) inclusion selection rule type; and
ii) exclusion selection rule type;
(c) each of said selection rules specifies a corresponding selection rule subset of the data object collection, wherein:
i) for a selection rule of said inclusion selection rule type, said selection rule subset is the union of said selection term subsets corresponding to said selection terms contained in said selection rule; and
ii) for a selection rule of said exclusion selection rule type, said selection rule subset is the complement of the union of said selection term subsets corresponding to said selection terms contained in said selection rule; and
(d) the query data structure specifies a query result subset of the data object collection, wherein said query result subset is the intersection of said selection rule subsets corresponding to said selection rules of the query.

2. The query data structure of claim 1, wherein each of said selection terms is of a type selected from the group consisting of:
i) pre-existing arbitrary subset type; and
ii) pre-existing query type.

3. The query data structure of claim 1, wherein the data object collection has at least one data object containing a formal data attribute, and wherein each of said selection terms is of a type selected from the group consisting of:
i) pre-existing arbitrary subset type;
ii) pre-existing query type; and
iii) mathematical expression on the formal data attribute.

4. The query data structure of claim 1, said non-empty set of machine-readable selection rules containing a plurality of selection rules at least one of which contains a non-empty set of machine-readable selection terms containing a plurality of selection terms, and wherein each of said selection terms is of a type selected from a group consisting of:
i) pre-existing arbitrary subset type;
ii) pre-existing query type; and
iii) text search.

5. A method for automatically evaluating a query by a data processing device and retrieving machine-readable data objects specified by the query from a data object collection, the query containing a non-empty set of machine-readable selection rules, at least one of which contains a non-empty set of machine-readable selection terms, wherein each selection rule is of a type selected from the group consisting of inclusion selection rule type and exclusion selection rule type, the method comprising:
(a) providing storage for a query result subset;
(b) providing storage for a selection rule result subset;
(c) for each selection rule:
i) determining the selection terms;
ii) for each selection term:
determining a selection term result subset;
replacing said selection rule result subset with the set union of said selection rule result subset and said selection term result subset;
iii) if the selection rule is of exclusion selection rule type, replacing said selection rule result subset with the complement of said selection rule subset; and
(d) replacing said query result subset with the set intersection of said query result subset and said selection rule subset.

6. A computer program product comprising machine-accessible data storage containing a computer program operative to execute the method of claim 5.

7. A system for automatically evaluating a query and retrieving machine-readable data objects specified by the query from a data object collection, the query including a set of selection rules, each including a set of selection terms, the system comprising:
(a) a selection rule extractor, for obtaining the selection rules of the query;
(b) a selection rule evaluator, for obtaining a selection rule result subset of the data object collection;
(c) a selection term extractor, for obtaining the selection terms of a selection rule;
(d) a selection term evaluator, for obtaining a selection term result subset of the data object collection;
(e) a union calculator, for producing said selection rule result subset in conjunction with said selection term extractor and said selection term evaluator, by calculating the set union of the selection term result subsets corresponding to the selection terms of a selection rule; and
(f) an intersection calculator, for producing a query result subset of the data object collection in conjunction with said selection rule extractor and said selection rule evaluator, by calculating the set intersection of the selection rule result subsets corresponding to the selection rules of the query;
wherein said query result subset contains the machine-readable data objects specified by the query.

8. The system of claim 7, wherein each selection rule is of a type selected from the group consisting of inclusion selection rule type and exclusion selection rule type, the system further comprising:
(g) an inclusion/exclusion discriminator for determining the type of each selection rule in the query; and
(h) a complement calculator, for calculating the set complement, in the data object collection, of a selection rule result subset corresponding to a selection rule of exclusion selection rule type.

9. The system of claim 7, wherein each selection term is of a type selected from the group consisting of:
i) pre-existing arbitrary subset type;
ii) pre-existing query type;
iii) mathematical expression on a formal data attribute; and
iv) text search.

10. A data terminal user interface for enabling a user to construct a machine-readable query data structure for specifying data objects to be retrieved from a data object collection, the query data structure containing a set of machine-readable selection rules, each containing a set of machine-readable selection terms, the user interface comprising:
(a) a presentation of selection rules, wherein the user can choose a selection rule therefrom;
(b) a presentation of selection terms, wherein the user can choose a selection term therefrom,
(c) a presentation of pre-existing subsets of the data object collection; and
(d) a cursor;
wherein the user can choose a pre-existing subset for constructing a selection term and a selection term for constructing a selection rule of the query data structure under construction.

11. The user interface of claim 10, further comprising:
(e) a presentation of pre-existing queries.

12. The user interface of claim 10, wherein a selection rule is of a type selected from the group consisting of inclusion selection rule type and exclusion selection rule type, the user interface further comprising:
(e) a presentation of the type of selection rule.

13. The user interface of claim 10, wherein a selection term is operative to text searching, the user interface further comprising:
(e) a presentation of text; and
(f) an input device for text typing.

14. The user interface of claim 10, furthermore operative to enable a user to modify an existing query data structure.
